(19) United States
(12) Patent Application Publication
(10) Pub. No.: US 2007/0133836 A1
(43) Pub. Date: Jun. 14, 2007

(54) Wireless headset and control method thereof

(75) Inventor: Young-Soon Lee, Busan (KR)

Correspondence Address: GWIPS;PETER T. KWON, P.O. BOX 231630, CENTERVILLE, VA, 20120, US

(73) Assignee: Simplebe Co., Ltd.

(21) Appl. No.: 11/604,820

(22) Filed: Nov. 27, 2006

(30) Foreign Application Priority Data
Nov. 28, 2005 (KR) 10-2005-0113925
Jan. 25, 2006 (KR) 10-2006-0007558
Jan. 25, 2006 (KR) 10-2006-0007559

(51) Int. Cl. H04R 25/00

(52) U.S. Cl. 381/370; 381/380; 381/381

(57) ABSTRACT

A foldable wireless headset is introduced comprising an elongated bar-shape main body, a hinged earphone attached at the proximal end of the main body, and an earphone position guidance for maintaining the earphone stationary at the selected position with respect to the main body either one of an extending position, retracting position and intermediate position. The wireless headset enhances operational stability, saves manufacturing costs, is easily carried, and is convenient to use. Also, the wireless headset can be automatically turned on and off in response to the extraction and retraction of the earphone.

### BACKGROUND OF THE INVENTION

1. Field of the Invention

The present invention relates to a wireless headset, in particular, one which is separated from a main body for transmitting/receiving wireless signals, and designed to convert a wireless signal received from the main body into sound waves, such that a user is not restricted by cords but can use both hands freely while listening via the headset. The invention also relates to a control method of the same wireless headset.

2. Description of the Prior Art

As generally known in the art, separate wireless headsets have become commonly used as accessories for electronic devices such as mobile phones and MP3 players. By using such a wireless headset, a user can use an electronic device such as a mobile phone or an MP3 player without having to hold it in his or her hand. The usage of such a wireless headset has been enabled by the development of local wireless communication technologies such as Bluetooth, Wireless LAN (WLAN), Wireless Personal Area Network (WPAN) and Radio Frequency Identification (RFID).

The wireless headset is typically provided with a frame, which is shaped in a similar manner to the human ear, and can be made integral with or separate from the wireless headset. The frame of the wireless headset is hung on the ear so that the wireless headset can remain stationary at a mounting position. However, this frame is inconvenient to use since a user must attach the headset through a complicated operation. For example, the user must hook the frame around his or her ear and/or deform the frame, and it is not easy at all to attach the wireless headset in the correct position. Furthermore, the frame increases the overall size of the wireless headset, and due to its hook-like configuration, is frequently snagged on other objects, such as a pocket.

To overcome such problems, an approach has been introduced in which a wireless headset is attached to the ear by inserting an earphone into the external auditory canal without having to be hooked around the pinna, or exterior ear. In this case, a user can attach the wireless headset by inserting the earphone of the wireless headset directly into a gap between the tragus and the antitragus, thus locating it within the external auditory canal.

A prior art of the wireless headset has been proposed in Korean Registered Utility Model No. 20-0393227. According to this document, the wireless headset is directly hung on the ear of the user, and the earphone is designed to project out of the body of the wireless headset when the wireless headset is in use, but to retract into a space in the central portion of the headset body when the wireless headset is stored.

However, this approach has a drawback in that the wireless headset has limited space inside for components. In other words, since a large cavity is needed in the central portion of the wireless headset to ensure space to store the earphone, other components necessary for the operation of the wireless headset must be placed in other areas. As a result, the wireless headset needs to be increased in size to be equipped with all the necessary components.

In addition, since an elongated ear set is directly connected to the earphone and rotated via a hinge, the outer end of the ear set protrudes outward when the wireless headset is attached to the user. When the protruding end of the ear set is caught by other objects, the wireless headset is separated from the ear.

Furthermore, since a torsion spring constantly applies a one-sided force to the earphone, the earphone is likely to be pushed outward by even a weak external impact. Therefore, the wireless headset can rarely afford normal operation.

In addition, since the earphone is stored inside the body, it is difficult to extend and retract the earphone out from/into the body.

Moreover, there is an inconvenience that the on/off button must be pushed to operate the wireless headset before every conversation, in addition to the extraction of the earphone.

### SUMMARY OF THE INVENTION

Accordingly, the present invention has been made to solve the above-mentioned problems occurring in the prior art, and an object of the present invention is to provide a wireless headset which can operate stably and normally, be reduced in size and manufacturing cost, stably maintain its given shape and structure even when an external impact is applied thereto, and be easily carried and used more conveniently by a user.

Another object of the invention is to provide a wireless headset which can be stably attached to an ear, stably maintain its given shape and structure in a given position even when an external impact is applied thereto, be reduced in size and manufacturing cost, be manufactured simply, be easily carried by a user, be operated merely by extracting an earphone without having to perform additional manipulation, and in which an earphone has a shape protruding from a body to thereby be extracted more easily, and in which the power of the headset is controlled merely through the extraction/retraction of the earphone.

A further object of the invention is to provide a wireless headset which can be stably attached to an ear of a user while remaining stationary with the earphone in an extended position, thereby improving portability, storage and usability of the wireless headset, and in which stationary positions of the earphone are provided at various angles so that the user can select a stationary position according to his or her preference.

According to an aspect of the invention, there is provided a wireless headset comprising: an elongated bar-shaped body; a hinged earphone arranged at an upper or lower end of the body; and an earphone location guide structure for maintaining the earphone stationary with respect to the body in at least one position selected from the group consisting of an extended position, a retracted position and an intermediate position between the extended and retracted position.

According to another aspect of the invention, there is provided a wireless headset comprising: a body; an earphone guide recess depressed into the body; an earphone arranged in the earphone guide recess, hinged so that it can fold with respect to the body to be extracted; an earphone location guide structure for maintaining the earphone stationary in at least one of two positions—extended from the body or fully retracted into the body; and a extender for enabling the earphone to remain separated from the body in the extended position.

According to yet another aspect of the invention, there is provided a wireless headset comprising: a bar-shaped body; an earphone guide recess depressed into the body; an earphone placed in the earphone guide recess; an elastic hinge arranged at a joint between the earphone and the body to provide an elastic torque on the earphone, thereby keeping the earphone stationary in at least one extended position; and a extender for enabling the earphone to remain separated from the body in the extended position.

According to another aspect of the invention, there is provided a wireless headset comprising: a body; a hinged earphone that can rotate with respect to the body to be extracted out; an earphone location guide structure for maintaining the earphone stationary with respect to the body; and a clip coupled to the body, for enabling the body to be hung.

According to still another aspect of the invention, there is provided a wireless headset comprising: a body; an earphone guide recess depressed into the body; an earphone arranged in the earphone guide recess, hinged such that it can fold with respect to the body to be extracted out; a extender for enabling the earphone to remain separated from the body in the extended position; a rotating shaft arranged at an end of the extender; a rotation guide that can rotate together with the rotating shaft, the rotation guide having a polygonal cross section including at least one planar portion; and an elastic member for providing an elastic force to rotate the rotation guide in such a way as to be in surface contact with the planar portion of the rotation guide.

According to another aspect of the invention, there is provided a wireless headset comprising: a body; an earphone guide recess depressed into the body; an earphone arranged in the earphone guide recess, hinged with respect to the body so as to be extracted out; a extender for enabling the earphone to remain separated from the body in an extended position; a rotating shaft arranged at an end of the extender; a guide plate rotating at the same angle as the rotating shaft; at least one stopper arranged equidistant from the center of the guide plate; an insert piece for being selectively caught by the stoppers; and an elastic member for pressing the insert piece toward the stopper.

According to yet another aspect of the invention, there is provided a wireless headset comprising: a body; an earphone guide recess depressed into the body; an earphone arranged in the earphone guide recess, hinged with respect to the body so as to be extracted out; a extender for enabling the earphone to remain separated from the body in an extended position; a rotating shaft that rotates together with the extender; a rotation guide having at least one planar portion that rotates together with the rotating shaft; and an elastic piece made of resin and formed integrally with a part of the body, the elastic piece providing an elastic force to rotate the rotation guide in such a way as to be in surface contact with the planar portion of the rotation guide.

According to another aspect of the invention, there is provided a wireless headset comprising: a body; an earphone guide recess depressed into the body; an earphone arranged in the earphone guide recess, hinged with respect to the body so as to be extracted out; a extender for enabling the earphone to remain separated from the body in an extended position; and a flexible portion made of an elastic material, the flexible portion formed at a joint between the earphone and the body, wherein the flexible portion is smoothly curved to guide extraction of the earphone when the earphone is extracted.

According to still another aspect of the invention, there is provided a wireless headset comprising: a bar-shaped body; an earphone that can rotate in a direction perpendicular to the longitudinal direction of the body; a extender arranged at a joint between the earphone and the body, the extender enabling the earphone to maintain separation from the body in an extended position; and an earphone location guide structure for maintaining the earphone stationary in at least one extended position.

According to another aspect of the invention, there is provided a wireless headset comprising: a body; an earphone hinged with respect to the body so as to be extracted out; a extender for enabling the earphone to remain separated from the body in an extended position; and an elastic hinge for enabling the earphone to rotate through a range of 180° and to remain stationary in at least one extended position.

According to yet another aspect of the invention, there is provided a wireless headset comprising: a bar-shaped body; an earphone guide recess formed in a cross sectional corner of the body; an earphone received in the earphone guide recess; a extender connected to a joint between the earphone and the body, the extender enabling the earphone to remain separated from the body in an extended position; and an earphone location guide structure for maintaining the earphone stationary in the extended position.

According to another aspect of the invention, there is provided a wireless headset comprising: a body provided with at least a Bluetooth module; an earphone guide recess depressed into the body; an earphone partially guided and placed inside the earphone guide recess; and an earphone location guide structure for maintaining the earphone stationary with respect to the body in at least one of an extended position and a retracted position, wherein the earphone guide recess supports the earphone to prevent the earphone from excessive rotation.

According to still another aspect of the invention, there is provided a wireless headset comprising: a body; an earphone hinged with respect to the body such that it can be extracted perpendicularly or horizontally with respect to a longitudinal direction of the body; an earphone location guide structure for maintaining the earphone stationary in at least one of a position extended from the body and another position retracted into the body; and a rotation detector for detecting the operation of the earphone and/or the earphone location guide structure to control power supplied to the wireless headset.

According to another aspect of the invention, there is provided a wireless headset comprising: a body; an earphone having a shape protruding from one end of the body, and arranged such that it can rotate with respect to the body; a extender for enabling the earphone to remain separated from the body when in an extended position; a stopper arranged on the extender enabling the earphone to remain stationary in at least one of two positions—extended or retracted; a support for interacting with the stopper in order to maintain the earphone stationary in at least one of the extended position or the retracted position; an extension/retraction operator for removing a supporting force from the support, in order to return the earphone from the extended position to the retracted position or from the retracted position to the extended position; and a stopper-side elastic member arranged at a joint between the earphone and the body to provide an elastic torque on the earphone in order to return the earphone from the extended position to the retracted position or vice versa.

According to yet another aspect of the invention, there is provided a wireless headset comprising: a body; an earphone hinged such that it can rotate in a direction perpendicular to a longitudinal direction of the body; a extender for enabling the earphone to remain separated from the body when in an extended (?) position; a rotating shaft arranged at an end of the extender; a rotation guide that rotates together with the rotating shaft having a polygonal cross section including at least one planar portion; and an elastic member for providing an elastic force to rotate the rotation guide in such a way as to be in surface contact with the planar portion of the rotation guide.

According to still another aspect of the invention, there is provided a wireless headset comprising: a body; an earphone hinged with respect to the body; a extender arranged between the earphone and the body, the extender enabling the earphone that is in the extended position to have a longer distance from the body than in the retracted position; a rotator connected to the earphone that rotates together with the earphone; a flexible portion connected to the rotator and having at least two indentations; and a rotation stopper for interacting with the flexible portion to maintain the earphone stationary while the earphone is being used in order to prevent rotation of the rotator.

According to another aspect of the invention, there is provided a wireless headset comprising: a body; an earphone that can move with respect to the body; a extender for enabling the earphone to remain separated from the body when in an extended position; a rotating shaft connected to the earphone to move together with the earphone; a flexible portion with alternating protrusions and indentations; and a protruding rotation stopper formed on one side of the rotating shaft that can mesh with the indentations of the flexible portion to prevent rotation of the rotating shaft; and an elastic member for providing the rotation stopper with an elastic force toward the flexible portion.

According to yet another aspect of the invention, there is provided a wireless headset comprising: a body; an earphone movable with respect to the body; a extender for enabling the earphone to remain separated from the body when in an extended position; a rotating shaft connected to the earphone to rotate together with the earphone; a flexible portion shaped into a gear and arranged on a portion of the rotating shaft; a ratchet that can mesh with the gear of the flexible portion to prevent rotation of the rotating shaft; a ratchet shaft for supporting the ratchet; and an elastic member for providing an elastic torque on the ratchet.

According to still another aspect of the invention, there is provided a wireless headset comprising: a body; an earphone that can move with respect to the body; a extender for enabling the earphone to remain separated from the body when in an extended position; a rotating shaft connected to the earphone to move together with the earphone; a non-circular flexible portion formed on one side of the rotating shaft and having at least two indentations; a rotation stopper that can mesh with at least one of the indentations to prevent rotation of the rotating shaft; and an elastic member for providing an elastic force so that the rotation stopper maintains its initial position.

According to yet another aspect of the invention there is provided a control method of a wireless headset, comprising the steps of: when an earphone is extracted, detecting the extraction of the earphone by triggering a rotation detector; and switching the wireless headset to a connection mode via the rotation detector.

According to still another aspect of the invention, there is provided a control method of a wireless headset, comprising the steps of: when an earphone is retracted, detecting the retraction of the earphone by triggering a rotation detector; and switching the wireless headset to a standby mode via the rotation detector.

According to the present invention as proposed above, the wireless headset can be enhanced in operational stability, can reduce manufacturing costs, can be easily carried, and can be used more conveniently.

Furthermore, the wireless headset can be automatically turned on/off in response to the extraction/retraction of the earphone, and thus used conveniently.

### BRIEF DESCRIPTION OF THE DRAWINGS

FIG. 1 is a perspective view illustrating a wireless headset of the invention.

FIG. 2 is a cross-sectional view taken along the line II-II′ of FIG. 1.

FIG. 3 is a cross-sectional view taken along the line I-I′ of FIG. 1.

FIGS. 4 and 5 are cross-sectional views illustrating retracting/extracting operations of an earphone into or out of a wireless headset according to a first embodiment of the invention, in which FIG. 4 shows a position during the retraction/extraction of the earphone, and FIG. 5 shows an extended position.

FIG. 6 is a view illustrating the angle and offset of the wireless headset according to the first embodiment of the invention.

FIGS. 7 and 8 are vertical cross-sectional views illustrating a wireless headset according to a second embodiment of the invention.

FIGS. 9 and 10 are vertical cross-sectional views illustrating a wireless headset according to a third embodiment of the invention.

FIGS. 11 and 12 are vertical cross-sectional views illustrating a wireless headset according to a fourth embodiment of the invention.

FIGS. 13 and 14 are vertical cross-sectional views illustrating a wireless headset according to a fifth embodiment of the invention.

FIG. 15 is a vertical cross-sectional view illustrating a wireless headset according to a sixth embodiment of the invention.

FIG. 16 is a perspective view illustrating the wireless headset according to the sixth embodiment of the invention.

FIG. 17 is a plan view illustrating the wireless headset according to the sixth embodiment of the invention.

FIG. 18 is a perspective view illustrating a wireless headset according to a seventh embodiment of the invention.

FIG. 19 is a cross-sectional view of a wireless headset according to an eighth embodiment of the invention, taken along the line II-II′ of FIG. 1.

FIG. 20 is a cross-sectional view of the wireless headset according to the eighth embodiment of the invention, taken along the line I-I′ of FIG. 1.

FIGS. 21 and 22 are cross-sectional views illustrating the retracting/extracting operations of an earphone into or out of the wireless headset according to the eighth embodiment of the invention, in which FIG. 21 shows a position during the retraction/extraction of the earphone, and FIG. 22 shows an extended position.

FIG. 23 is a block diagram illustrating a switch of the wireless headset according to the eighth embodiment of the invention.

FIG. 24 is a block diagram illustrating operation modes of the wireless headset according to the eighth embodiment of the invention.

FIGS. 25 to 27 are vertical cross-sectional views illustrating a wireless headset according to a ninth embodiment of the invention.

FIG. 28 is a perspective view illustrating a wireless headset according to a tenth embodiment of the invention.

FIG. 29 is a vertical cross-sectional view illustrating the wireless headset according to the tenth embodiment of the invention.

FIG. 30 is a plan view illustrating the wireless headset according to the tenth embodiment of the invention.

FIG. 31 is a cross-sectional view of a wireless headset according to an eleventh embodiment of the invention, taken along the line II-II′ of FIG. 1.

FIG. 32 is a cross-sectional view of the wireless headset according to the eleventh embodiment of the invention, taken along the line I-I′ of FIG. 1.

FIGS. 33 and 34 are vertical cross-sectional views illustrating a wireless headset according to a twelfth embodiment of the invention.

FIGS. 35 and 36 are vertical cross-sectional views illustrating a wireless headset according to a thirteenth embodiment of the invention.

FIGS. 37 and 38 are vertical cross-sectional views illustrating a wireless headset according to a fourteenth embodiment of the invention.

### DETAILED DESCRIPTION OF THE PREFERRED EMBODIMENTS

Hereinafter preferred embodiments of the present invention will be described in detail with reference to the accompanying drawings. However, these embodiments are provided for illustrative purposes and the principle of the invention is not limited thereto. Rather, those skilled in the art will appreciate that various additions, modifications, cancellations and substitutions are possible without departing from the scope and spirit of the invention as disclosed in the accompanying claims.

### Embodiment 1

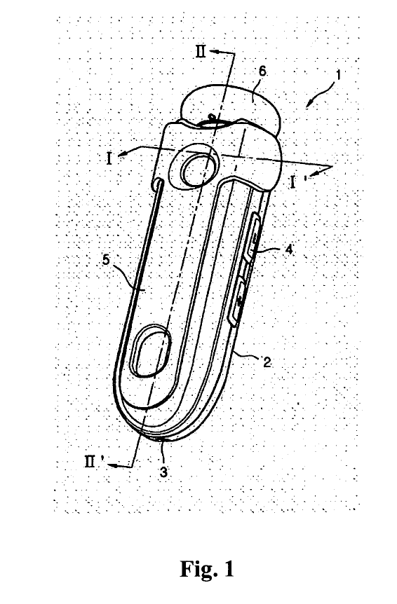

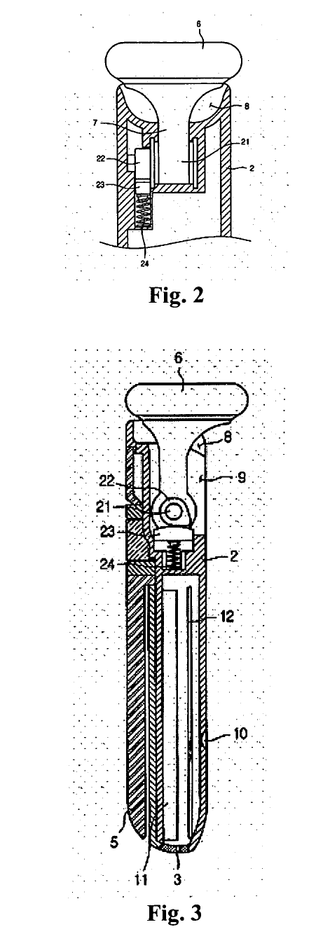

FIG. 1 is a perspective view illustrating a wireless headset 1 of the invention, FIG. 2 is a cross-sectional view taken along the line II-II′ of FIG. 1, and FIG. 3 is a cross-sectional view taken along the line I-I′ of FIG. 1.

Referring to FIGS. 1 to 3, the wireless headset 1 of the invention includes a body 2 in the form of an elongated bar and an earphone 6 mounted on the upper end of the body 2 such that it can rotate. A user can easily operate the wireless headset 1 by holding the body 2 with one hand and manipulating the earphone 6 with the fingers of the hand.

On the exterior of the body 2, the headset 1 also includes a volume controller 4 by which the user can control the volume, a clip 5 for allowing the user to easily attach the wireless headset 1, a microphone 3 for converting the user's voice into electrical signals and an on/off button 10 used for powering on or off the wireless headset 1. In addition, a charging terminal (not shown) for charging a battery 11 may be provided at one part of the body 2.

Inside the body 2, there are installed a Bluetooth module for wirelessly communicating with a main body such as an MP3 player or a mobile phone, an amplifier circuit for amplifying signals to be transmitted and received by the Bluetooth module, and a circuit for reproducing the amplified signals into electrical signals of sound waves. Of course, these elements function to operate the wireless headset 1. These elements or circuits are preferably provided on a board 12 arranged inside the body 2.

In addition, a speaker (not shown) for converting electrical signals into audio signals through the vibration of air is installed inside the earphone 6. The earphone 6 has an insert member made of a soft material at one end thereof. The insert member is deformed flexibly when inserted into an ear of the user, and thus can stably maintain its inserted position. Accordingly, the earphone 6 with the insert member does not need any shape or frame conforming to the external ear of the user that serves to hold the wireless headset on the ear.

With such a structure, the user can conveniently operate the wireless headset 1 by holding the body 2 with one hand and manipulating the earphone 6 with a finger of the hand holding the body 2. That is, the earphone 6, shaped to protrude from the body 2, further facilitates the operation of the wireless headset 1.

As one of characteristic features of the wireless headset 1 of the invention, the earphone 6 can be moved easily, and constructions associated therewith will now be described in detail.

A rod-shaped extender 7 is arranged at a joint between the earphone 6 and the body 2 to provide a specific separation between the earphone 6 and the body 2. The body 2 has an earphone guide recess 8 for guiding the location of the earphone 6 and an extender guide recess 9 for guiding the location of the extender 7.

In detail, when the earphone 6 is extracted outward from the wireless headset 1 to be inserted into the ear of the user during the use of the wireless headset 1, the extender 7 serves to prevent the earphone 6 from being caught by the ear of the user, which could otherwise obstruct the insertion of the earphone 6. That is, the extender 7 maintains a specific gap between the ear of the user and the body 2 so that the wireless headset 1 is not caught by the user's ear. In addition, the earphone guide recess 8 is depressed along a large width into the body 2 from the end thereof to provide a seating space for the earphone 6 which is retracted to a position adjacent to the body 2 during storage of the wireless headset 1. The extender guide recess 9 serves to guide the movement of the extender 7 while the earphone 6 is extracted from the body 2 for the use of the wireless headset 1 or while the earphone is in the extended position.

While it is shown in the drawings that a large part of the earphone 6 protrudes out of the earphone guide recess 8, the principle of the invention is not limited thereto. Most of the earphone 6 may be received inside the earphone guide recess 8. As an alternative, it is preferable that at least a portion of the earphone 6 is exposed outside of the earphone guide recess 8 so that the user can easily extract and operate the earphone 6. As the earphone 6 is mounted at the end of the bar-shaped body 2, the user can easily extract the earphone 6 by feel, without having to look at the earphone 6, to put the headset 1 into an operating position.

The earphone 6 can pivot with respect to the body 2. The hinged earphone 6 is correctly guided to the seating position in the earphone guide recess 8 and to the extended position protruding out from the body 2.

The earphone 6 is rotated with respect to the body 2 to a position shown in FIG. 6. In this position, the center line C2 of the earphone 6 is tilted with respect to the extension line C1 of the upper surface of the body 2. The angle A between the extension line C1 and the center line C2 is in the range from 5° to 20°, and preferably between 10° and 15°. When the earphone 6 has been rotated about the body 2 and is fixed in this position, the offset B between the underside of the earphone 6 and the upper surface of the body 2 is in the range from 2 mm to 8 mm, preferably between 4 mm and 5 mm. FIG. 6 illustrates the angle and offset of the wireless headset according to the first embodiment of the invention.

Now a structure for guiding the location of the earphone 6 will be described in detail.

First, a rotating shaft 21 is provided at the lower end of the extender 7, extended perpendicular to the longitudinal direction of the extender 7, and a cam 22 is formed at the end of the rotating shaft 21. A stud 23 is arranged to contact the cam 22, and an elastic member 24 is connected to one end of the stud 23 which faces away from the cam 22.

With this structure, the elastic member 24 constantly applies upward force to the stud 23 which is in constant contact with the cam 22 so that the upper end of the stud 23 imparts force to the cam 22, thereby positioning the cam 22 at a specific rotation angle. Accordingly, the cam 22 is rotated via the rotating shaft 21 when the earphone 6 is rotated. The cam 22 is formed in a non-circular configuration, and is pushed upward by the stud 23 to impart a force to the earphone 6 so that the earphone 6 is always moved to a preset location. The earphone 6 remains stable through the interaction between the cam 22 and the stud 23 in specific positions. In one position, the earphone 6 is received into the earphone guide recess 8 with the wireless headset 1 not in use. In another position, the earphone 6 is extended out completely with the wireless headset 1 in use. In an intermediate position, the cam 22 is put into an unstable position and thus provides a force to rotate in either direction.

Owing to the location guide structure for the earphone 6, when the wireless headset 1 is not operating, that is, when the earphone 6 is stored inside the earphone guide recess 8, the interaction between the cam 22 and the stud 23 prevents the earphone 6 from being extracted out until a specific magnitude of external force is applied to the earphone 6. As a result, this may advantageously prevent the earphone 6 from being extracted under external impact when the wireless headset 1 is being carried in a pocket or bag. This structure may also improve sanitary conditions, the convenience to the user of the earphone 6 and the operational stability of the wireless headset 1.

When the earphone 6 and the extender 7 are turned back toward the extended position by the earphone location guide structure, the earphone guide recess 8 and/or the extender guide recess 9 may function to guide the earphone 6 and the extender 7 and stop them in the correct position without being pushed backward further.

The operation or function of the invention will be described in more detail with reference to the above-mentioned structure.

First, the storage position of the wireless headset 1 will be described in principle. Typically, the wireless headset 1 is carried by the user like a mobile phone, and preferably located in a position where the user can reach the headset 1 at any time. For this purpose, a clip 5 is provided on one side of the body 2 of the wireless headset 1, and fixed to the body 2 as a separate piece. The clip 5 has a shape extending from one end of the body 2 to the other, and is flexible to a specific degree. Therefore, the user can easily hang the wireless headset 1 on a shirt pocket by using the clip 5. When using the wireless headset 1 to answer a call on the mobile phone, the user can easily take the wireless headset 1 out of his/her pocket.

Of course, the clip 5 shown in the drawings is merely an embodiment but can be provided in various forms. For example, the clip 5 may be provided integrally with the body 2.

The usage of the clip 5 is further enhanced when the wireless headset 1 of this invention is shaped as a bar. When the wireless headset 1 is shaped as, for example, a pen, the clip 5 can enable the wireless headset 1 to be hung on a pocket, thereby further improving the usage thereof.

Furthermore, in a storage position of the wireless headset 1, the earphone 6 is received in the body 2; more particularly, the earphone is seated inside the earphone guide recess 8. Since the earphone 6 is arranged along the longitudinal direction of the wireless headset 1, there is an advantage in that the earphone 6 is not interfered with by external objects. Furthermore, even if the earphone 6 is snagged on an external object, the earphone location guide structure stably supports the earphone 6 in position, thereby preventing it from being extracted outward unintentionally. Due to such a stable structure, the operational stability of the wireless headset 1 is greatly improved.

The process of using the wireless headset 1 will be described in more detail.

When using the wireless headset 1 to answer a call on the mobile phone, the user separates the clip 5 to pull out the wireless headset 1 and rotates the earphone 6 to extract it. To describe this process in more detail, the user pushes a part of the earphone 6 that is protruding out of the earphone guide recess 8 with the hand that is holding the body 2. This rotates the earphone 6 about the rotating shaft 21, which rotates outward swiftly through the interaction between the cam 22 and the stud 23.

Since the earphone 6 can be extracted swiftly, as above, there is an advantage in that user convenience can be further improved. Once extracted from the body 2, the earphone 6 remains stationary in the extended position due to a force acting between the cam 22 and the stud 23 until the user pushes the earphone 6 inward with a force equal to that exerted for the extraction of the earphone 6. Thus, the earphone 6 can remain stable in the extended position when inserted into the ear. As a result, the earphone 6 can be inserted into the ear precisely and conveniently.

When the earphone 6 is extracted, the extender 7 is extended to a preset length so that the body 2 does not interfere with any external object such as the pinna of the user's ear, when the earphone 6 is inserted into the ear. The inserted position of the wireless headset 1 can be maintained securely and stably. The extender 7 can be provided in a length suitable for the above-mentioned objective. Since the extender 7 is guided by the extender guide recess 9, it is possible to prevent the earphone 8 from being broken by external impact. That is, since the extender 7 and the extender guide recess 9 conform to each other, when external impact is applied to the earphone 6, the cam 22, the rotating shaft 21 and the stud 23 can be significantly protected from the force of the impact. Of course, the extracting and retracting operations of the extender 7 are guided by the extender guide recess 9.

After the earphone 6 is completely extracted, the on/off button 10 can be operated to start the wireless headset 1. After the telephone call is finished, the on/off button 10 may be pushed again to terminate the operation of the wireless headset 1. During the operation, the volume may be controlled by the volume controller 4. Alternatively, the operational status of the wireless headset 1 can be controlled automatically by merely extracting the earphone 6 without having to operate the on/off button 10. For example, the wireless headset 1 can be automatically turned on when the earphone 6 is detected to be in the extended position. For this purpose, various sensors may be installed and used, examples of which may include a sensor for detecting the stud 23 being pressed by the cam 22 and a sensor installed inside the extender guide recess 9 to detect the movement of the extender 7. Such a sensor may be activated by detection of the rotation of the earphone 6 within the wireless headset 1, thereby further enhancing the usage of the wireless headset 1, where the earphone 6 is installed to be extended and retracted from/into the wireless headset 1, while improving user convenience.

In order to retract the earphone 6 inward when the operation of the wireless headset 1 is terminated, the user merely rotates the earphone 6 inward. This operation is exactly the reverse of the extraction operation, and thus a detailed description thereof will be omitted.

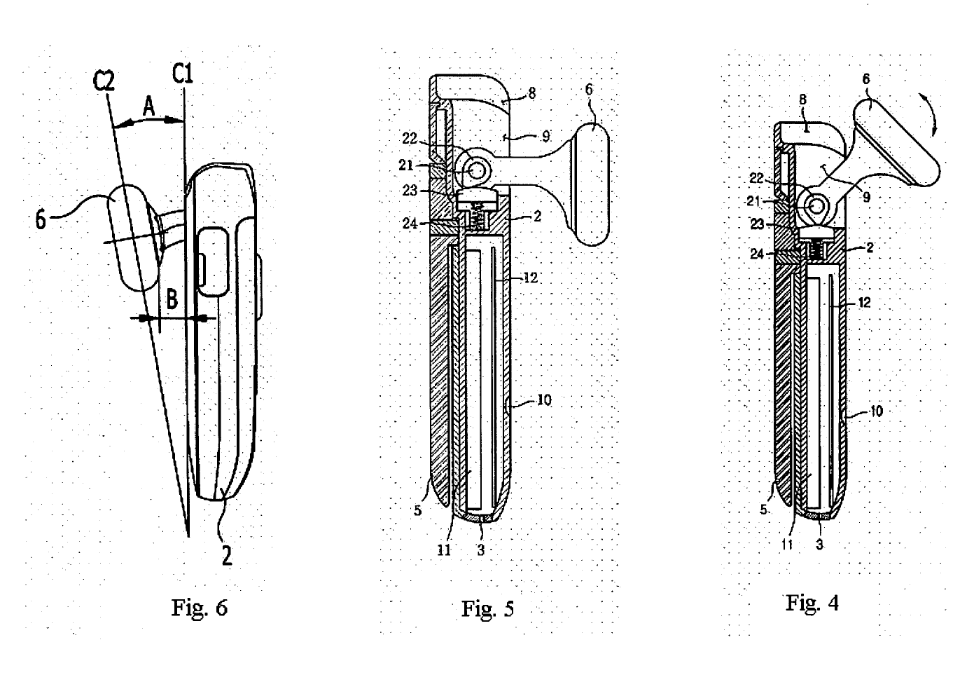

The extracting and retracting operations of the earphone 6 will be apparent with reference to FIGS. 3 to 5.

As explained briefly in the above description, the earphone 6, while in the storage position, is extended along the longitudinal direction of the body 2. On the other hand, in the operating position, the earphone 6 is at an angle with respect to the longitudinal direction of the body 2. That is, the earphone 6 rotates from the body 2 to be folded onto the body 2. Then, the earphone 6 moves farther away from the body 2, and as an advantageous result, the interference between the user's ear and the body 2 is reduced even more.

While not described in detail, any electrical connector structure such as a Flexible Printed Circuit Board (FPCB) may of course be provided to connect the earphone 6 with the board 12 in order to transfer electrical signals to the earphone 6.

The microphone 3 is arranged in the lower part of the wireless headset 1, which is closest to the mouth of the user, in order to effectively sense the user's voice.

According to this embodiment of the invention, the earphone 6 is arranged at one end of the wireless headset 1 in an elongated pen-like shape, and configured to extend along the longitudinal direction of the headset 1 and rotate to be folded into or out of the headset 1. This results in merits of improved structural convenience. Furthermore, since the earphone 6 is not installed in an inner cavity of the wireless headset 1, there are merits of improving convenience in the installation of internal components of the body 2 and promoting spatial efficiency thereof, thereby enabling the miniaturization of the wireless headset 1.

### Embodiment 2

This embodiment of the invention is substantially the same as the first embodiment except that a location guide structure for the earphone has different features. Accordingly, the same parts will not be described but can be understood with reference to the first embodiment. In the drawings, the same reference numerals are used to designate like elements throughout.

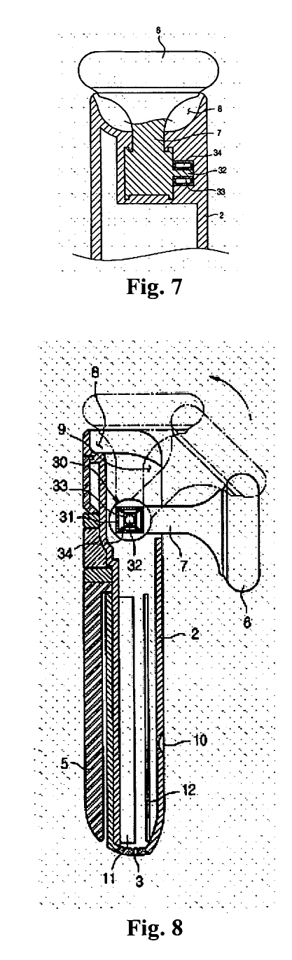

FIGS. 7 and 8 are vertical cross-sectional views illustrating the wireless headset according to the second embodiment of the invention, in which the cross section of the wireless headset is cut at the same angle as in FIGS. 2 and 3.

Referring to FIGS. 7 and 8, the earphone location guide structure of this embodiment is similar to the hinge structure for the folding cover of a folding-type mobile phone, or flip-phone. The earphone location guide structure has an elastic hinge 30 at a joint between the extender 7 and the body 2.

The structure of the elastic hinge 30 will now be described. The elastic hinge 30 of this embodiment includes a hinge body 31 forming an outside case, elastic members 34 loaded on the inside walls of the hinge body 31, a rotation guide 33 having a polygonal cross section, inserted between the elastic members 34, and a rotating shaft 32 for rotating through the same angle as the rotation guide 33 and the extender 7.

When the earphone 6 is rotated and extracted out of the earphone guide recess 8, the rotating shaft 32 and the rotation guide 33 are rotated, during which the rotation angle of the rotation guide 33 is controlled by the elastic members 34. That is, since the rotation guide 33 is provided with a polygonal cross section including at least one plane, the elastic members 34 allow the rotating shaft 32 to rotate to an angle corresponding to the plane of the rotation guide 33 and then prevent the shaft 32 from rotating further. In such an operational structure, the plane may be preferably formed on the rotation guide 33 in a position opposed to the elastic members 34 when the earphone 6 is completely extended and in a position opposed to the elastic members 34 when the earphone 6 is completely retracted.

With this construction, the earphone 6 can be supported stably in the extended and retracted positions with respect to the earphone guide recess 8 as in the first embodiment.

### Embodiment 3

The third embodiment of the invention is substantially the same as the first embodiment except that a location guide structure for the earphone has different features. Accordingly, the same parts will not be described but can be understood with reference to the first embodiment. In the drawings, the same reference numerals are used to designate like elements throughout.

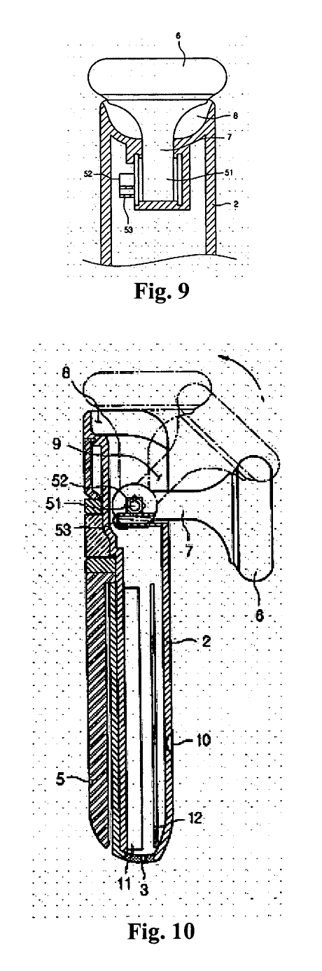

FIGS. 9 and 10 are vertical cross-sectional views illustrating a wireless headset according to the third embodiment of the invention, in which the cross section of the wireless headset is cut at the same angle as in FIGS. 2 and 3.

Referring to FIGS. 9 and 10, the earphone location guide structure of this embodiment includes an elastic hinge at a joint between the extender 7 and the body 2.

The structure of the elastic hinge will be described in detail. The elastic hinge of this embodiment includes a rotating shaft 51 formed at the lower end of the extender 7, a rotation guide 52 adapted to rotate with the rotating shaft 51 through the same angle, and an elastic piece 53 contacting the rotation guide 52.

To describe in more detail, the rotating shaft 51 and the rotation guide 52 are adapted to rotate at the same angle, and the rotation guide 52 has a polygonal cross section having at least one plane. The elastic piece 53 is provided integrally with a part of the body 2, and folded in at least one direction to impart a preset elastic force. If the body 2 is made of resin, the elastic piece 53 may also be made of resin to facilitate fabrication. Although the elastic member 53 may of course be made of a piece separate from the body 2 and inserted into the body 2, it is preferable that the elastic member 53 is manufactured simultaneously with the body 2 and integrally with a part of the body 2 in order to save manufacturing cost and add convenience.

To describe this embodiment, when the earphone 6 is rotated and extracted out of the earphone guide recess 8, the rotating shaft 51 and the rotation guide 52 are rotated and the rotation angle of the rotation guide 52 is controlled by the elastic piece 53. That is, the rotation guide 52 has a cross section including at least one plane so that the elastic piece 53 rotates the rotating shaft 51 to an angle corresponding to the plane of the rotation guide 52. In such an operational structure, the plane may be preferably formed on the rotation guide 52 in a position opposed to the elastic piece 53 when the earphone 6 is completely extended and a position opposed to the elastic piece 53 when the earphone 6 is completely retracted, so that the earphone 6 is guided correctly to the extended and retracted positions.

Of course, if the rotation guide 52 is provided with at least two planes, multiple stationary positions may be provided. This case can be applied to a situation where the user wants the earphone 6 to be attached to his/her ear in various positions.

### Embodiment 4

The fourth embodiment of the invention is substantially the same as the first embodiment except that a location guide structure for the earphone has different features. Accordingly, the same parts will not be described but can be understood with reference to the first embodiment. In the drawings, the same reference numerals are used to designate like elements throughout.

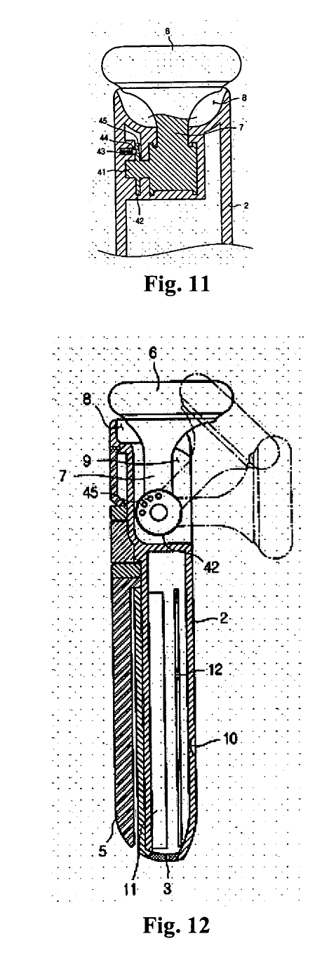

FIGS. 11 and 12 are vertical cross-sectional views illustrating a wireless headset according to the fourth embodiment of the invention, in which the cross section of the wireless headset is cut at the same angle as in FIGS. 2 and 3.

Referring to FIGS. 11 and 12, the wireless headset includes a rotating shaft 41 formed at the lower end of the extender 7, a guide plate 42 provided at a portion of the rotating shaft 41 that rotates coaxially with the rotating shaft 41, stoppers 45 arranged radially around and distanced equally from the rotation center of the guide plate 42, an insert ball 44 that can be inserted at least partially into one of the stoppers 45 to stop the rotation of the guide plate 42, and an elastic member 43 for pushing the insert ball 44 into the stopper 45. The stoppers 45 may be provided in the form of a recess formed in the guide plate 42.

To describe the operation of this embodiment, when aligned with one of the stoppers 45, the insert ball 44 resists the rotation of the stopper 45. Then the guide plate 42 is restrained from rotating unless the external force exceeds a certain amount. In this position, when the earphone 6 is extended or retracted through rotation under an external force, the rotating shaft 41 and the guide plate 42 rotate together, and the rotation of the guide plate 42 moves the stopper 45 out of alignment with the insert ball 44. That is, as a plurality of the stoppers 45 are provided, the stoppers 45 are aligned in turn with the insert ball 44 in response to the rotation angle of the guide plate 42.

If the stopper 45 is provided in a position that is aligned with the insert ball 44 when the earphone 6 is completely extended or retracted through this operation, the earphone 6 can stably remain in the extended or retracted position. Furthermore, when a plurality of the stoppers 45 is provided, it is possible to advantageously adjust the stationary position of the earphone 6 as desired by the user. In the drawings, four stoppers 45 are provided so that the user can locate the earphone 6 in four different stationary positions.

### Embodiment 5

The fifth embodiment of the invention is substantially the same as the first embodiment except that a location guide structure for the earphone has different features. Accordingly, the same parts will not be described but can be understood with reference to the first embodiment. In the drawings, the same reference numerals are used to designate like elements throughout.

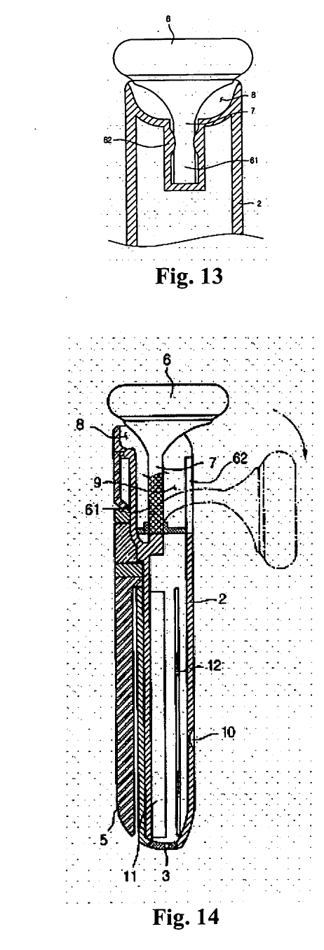

FIGS. 13 and 14 are vertical cross-sectional views illustrating a wireless headset according to a fifth embodiment of the invention, in which the cross section of the wireless headset is cut at the same angle as in FIGS. 2 and 3.

Referring to FIGS. 13 and 14, the earphone location guide structure of this embodiment includes an elastic hinge provided at a joint between the extender 7 and the body 2, as in the first embodiment. However, according to characteristic features of this embodiment, the hinge is not provided in a specific point but a portion of the extender 7 itself is made of an elastic material so that the extender 7 is bent smoothly when the earphone 6 is extracted. Therefore, the rotation operation of the hinge is not carried out at a specific point.

To describe in detail, the extender 7 of this embodiment is provided to be coupled with a component of the body 2, and includes a flexible portion 61 made of a soft material. As a result, the flexible portion 61 is smoothly rotated and elastically deformed when the earphone 6 is extracted outward.

The flexible portion 61 may be connected to the body 2 by injection molding the body 2 first and double-injection molding the flexible portion 61 onto the body 2. Alternatively, the flexible portion 61 may be inserted (or assembled) into the body 2, which has been manufactured previously. For the sake of convenience, it is preferable to manufacture the flexible portion 61 by double-injection molding.

In the meantime, protrusions 62 are formed at the outer edges of the extender guide recess 9, through localized reductions in the width of the recess 9. The protrusions 62 serve to guide the position of the extender 7 after the earphone has been extracted. Since the flexible portion 61 or the extender 7 passes through the protrusions 62, the user can easily extract the extender 7 and the earphone 6 by applying a certain amount of force to the earphone 6. Here, since the flexible portion 61 is constricted between the protrusions 62 as it is elastically deformed, it remains in the extended position once extracted. Therefore, once the user extracts the earphone 6, the earphone 6 advantageously remains in the extended position.

Although not described in detail, the extender 7 may be entirely made of the same material as the flexible portion 61. Alternatively, the extender 7 may be made of a material having a certain degree of solidity, unlike the flexible portion 61. An advantage resulting when the extender 7 is made of a somewhat solid material is that the operation of inserting the earphone 6 into the ear can be carried out more easily.

### Embodiment 6

The sixth embodiment of the invention is substantially the same as the first embodiment except that the rotation direction and the rotation status of the earphone 6 have different features. Accordingly, the same parts will not be described but can be understood with reference to the first embodiment. In the drawings, the same reference numerals are used to designate like elements throughout.

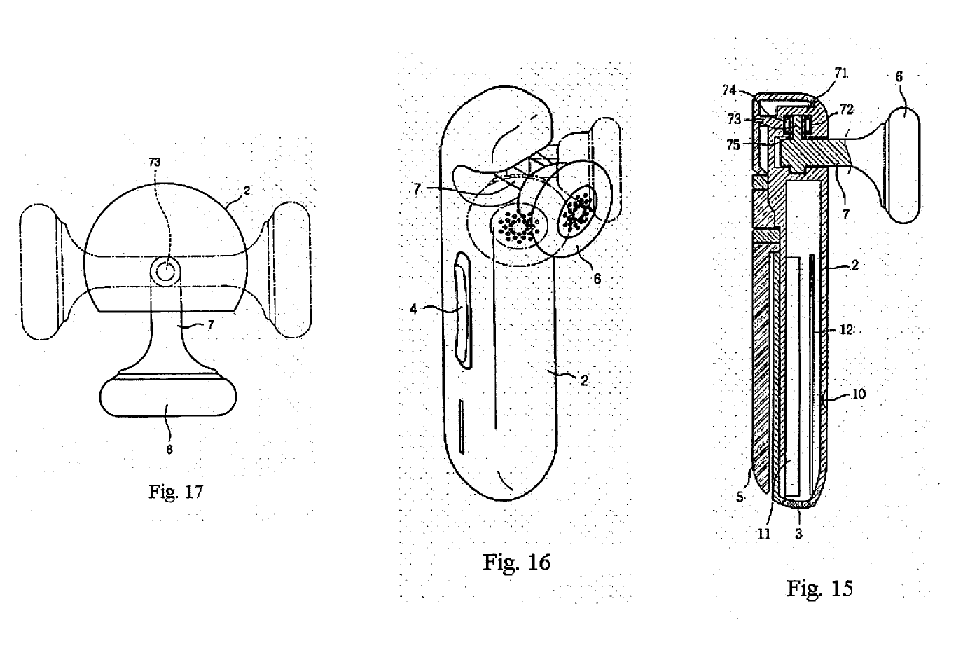

FIG. 15 is a vertical cross-sectional view illustrating a wireless headset according to a sixth embodiment of the invention, and FIG. 16 is a perspective view illustrating the wireless headset according to the sixth embodiment of the invention.

Referring to FIGS. 15 and 16, the wireless headset of this embodiment has the same characteristic features as the first embodiment in that the earphone 6 is arranged at the upper end of the wireless headset. However, the earphone 6 of this embodiment can rotate in a rotation plane perpendicular to the longitudinal direction of the wireless headset. This rotation plane is formed in the horizontal direction of FIG. 15. To achieve this operational feature, the body 2 is provided with a recess formed in a horizontal direction (along the rotation plane) and a vertically oriented rotating shaft 73 (parallel to the longitudinal direction of the wireless headset) mounted in the recess.

At a joint between the extender 7 and the body 2, the wireless headset has a structure the same as the earphone location guide structure which may be used in a flip-phone as described previously in the first embodiment.

To describe this structure in detail, an elastic hinge 71 is provided at one end of the extender 7, and the rotating shaft 73 is inserted into the elastic hinge 71, oriented vertically. The structure also includes a rotation guide 75 with a polygonal cross section and adapted to rotate at the same angle as the rotating shaft 73, an elastic member 74 for maintaining a stationary position in a specific range of angle during the rotation of the rotation guide 75, and a hinge body 72 for supporting the elastic member 74 from the inside.

In such a structure, the earphone 6 can be rotated over 180° in a horizontal direction, and the user can use the wireless headset by setting the earphone 6 to any desired position and fixing it in place.

FIG. 17 is a plan view illustrating the wireless headset of this embodiment, in which the range of rotation of the earphone 6 is illustrated. In FIG. 17, the positions where the earphone 6 is rotated to the right and left limit angles may be storage positions of the wireless headset. The position where the earphone 6 is located at the center of the rotation range may be a position where the wireless headset is used. This is because when the earphone 6 is located at the center of the rotation range, the extender 7 is located farthest from the body 2, so that there is no fear that the body 2 would touch the ear of the user.

In this embodiment also, as an advantageous effect, according to the rotation angle of the earphone 6, the earphone 6 can remain fixed in a stationary position unless a preset amount of external force is applied. Furthermore, when the earphone 6 is located at a rotation limit point, the gap between the extender 7 and the body 2 is small. That is, with this amount of separation, an external object may not easily contact the earphone 6, and thus the wireless headset can be easily carried. In addition, since the earphone 6 is arranged at one end of the bar-shaped body 2, the user can conveniently handle the wireless headset without any interference in carrying and storage.

While this embodiment has been described with the rotation angle limited to the range of 180°, the rotation angle may have various ranges that are smaller than 180°, such as 170°.

### Embodiment 7

The seventh embodiment of the invention is substantially the same as the sixth embodiment except for the range of the rotation angle of the earphone 6 and the position of the joint where the earphone 6 is connected to the body 2. Accordingly, the same parts will not be described but can be understood with reference to the sixth embodiment. In the drawings, the same reference numerals are used to designate like elements throughout.

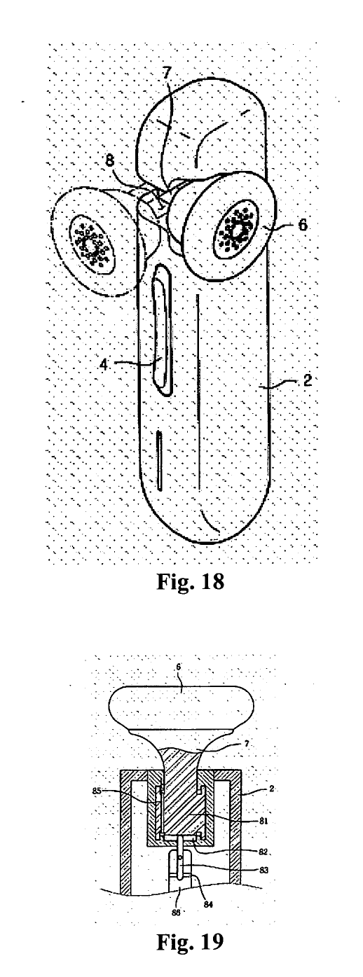

FIG. 18 is a perspective view illustrating a wireless headset of this embodiment.

Referring to FIG. 18, a joint where the extender 7 is connected to the body 2 is a corner portion of the body 2 when viewed in cross section. That is, if the body 2 has a non-circular cross section, and in particular, a rectangular cross section, the joint is provided in one corner of the rectangular cross section. To receive the earphone 6 during the retraction thereof, an earphone guide recess 8 is formed in the body 2 to receive the earphone 6 in a storage position.

To describe the wireless headset of this embodiment, the earphone 6 depicted with the solid line in FIG. 18 indicates the storage position thereof, where the earphone 6 is generally received inside the body 2 and partially protrudes from the body 2 so that the user can operate the earphone 6. The earphone 6 depicted with the dash-dot line indicates that it is in an operating position thereof, where the earphone 6 is positioned so as to maintain a predetermined separation from the body 2. Then, during the use of the wireless headset, the body 2 does not interfere with the ear of the user. In addition, the joint between the extender 7 and the body 2 is provided with an elastic hinge equivalent to or similar to that of the sixth embodiment, and thus the guidance of the earphone 6 into stationary positions may be easily expected.

As an alternative, the joint between the extender 7 and the body 2 may be relocated so that the dash-dot line indicates the earphone in the storage position, but the solid line indicates the earphone in the operating position. In this case, the earphone location guide recess 8 will be inserted deep into the body 2 from one side thereof.

Also according to this embodiment, the earphone 6 is arranged at one end of the elongated bar-shaped body 2 so that the user can conveniently operate the earphone 6 with one hand without any interference in the folding or storage thereof.

### Embodiment 8

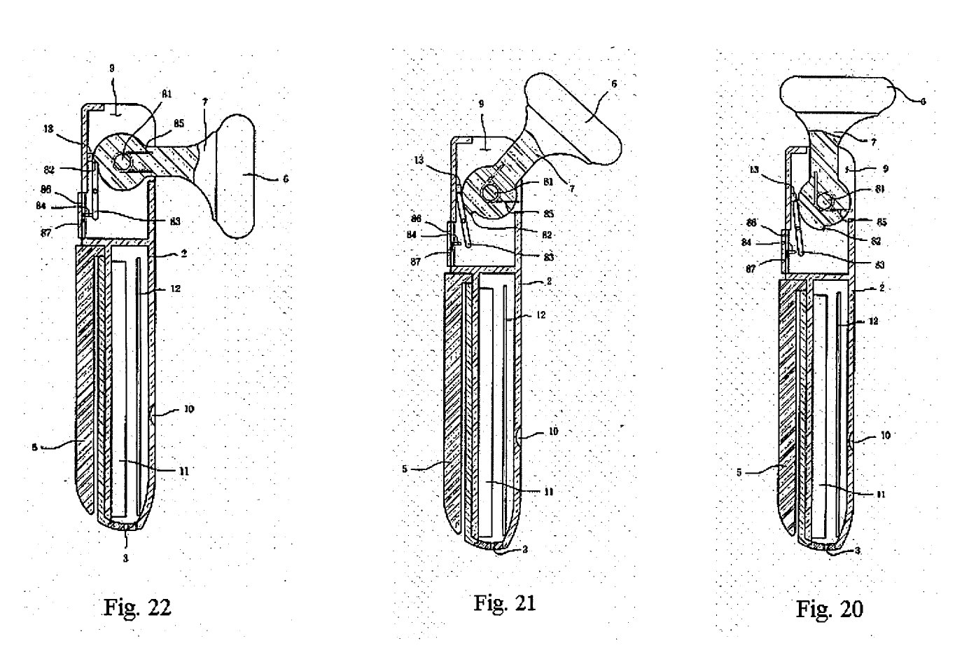

FIG. 19 is a cross-sectional view of a wireless headset according to an eighth embodiment of the invention, taken along the line II-II′ of FIG. 1, and FIG. 20 is a cross-sectional view of the wireless headset according to the eighth embodiment of the invention, taken along the line I-I′ of FIG. 1. FIGS. 21 and 22 are cross-sectional views illustrating the process of retracting an earphone into the wireless headset or extracting an earphone out of the wireless headset according to the eighth embodiment of the invention, in which FIG. 21 shows a position during the retraction/extraction of the earphone, and FIG. 22 shows the fully extended position.

As a characteristic feature of the wireless headset 1 of this embodiment, the movement of the earphone is carried out conveniently, which will be described as follows with reference to an associated construction.

The wireless headset 1 includes a body 2 and an earphone 6 mounted on one end of the body 2 such that it can rotate. At a joint between the earphone 6 and the body 2, an extender 7 is arranged to provide a gap of a specific size between the earphone 6 and the body 2. The body 2 has an extender guide recess 9 for guiding the location of the extender 7.

To be specific, the earphone 6 protrudes from either the upper or the lower end of the bar-shaped body, such that the user can easily extract the earphone 6 by feel, without having to look at the earphone 6 to put the headset 1 into an operating position. Such a protruding configuration can facilitate the miniaturization of the body 2 so that the body 2 can have a slim and compact shape.

Referring to FIG. 6 again, the earphone 6 is rotated to a stationary position with respect to the body 2. In this position, the center line C2 of the earphone 6 is tilted with respect to the extension line C1 of the upper surface of the body 2. The angle A between the extension line C1 and the center line C2 is in the range from 5° to 20°, and preferably from 10° to 15°. After the earphone 6 has been rotated about the body 2 to its fixed position, the offset B between the underside of the earphone 6 and the upper surface of the body 2 is about 2 mm to 8 mm, and preferably 4 mm to 5 mm.

To be specific, when the earphone 6 is extracted from the wireless headset 1 to be inserted into the ear of the user during the use of the wireless headset 1, the extender 7 serves to prevent the earphone 6 from being caught by the ear of the user, which may otherwise obstruct the insertion of the earphone 6. That is, the extender 7 maintains a certain minimum gap between the ear of the user and the body 2 so that the wireless headset 1 does not interfere with the user's ear. The extender guide recess 9 serves to guide the movement of the extender 7 while the earphone 6 is extracted from the body 2 for the use of the wireless headset 1 or after the earphone is extracted.

Now a structure for guiding the location of the earphone 6 will be described in detail.

First, a rotating shaft 81 is provided at the lower end of the extender 7, extending perpendicular to the longitudinal direction of the extender 7, and a stopper 82 is arranged at the lower end of the rotating shaft 81. The rotating shaft 81 is further connected with an elastic member 85 for providing an elastic force necessary for the earphone 6 to return to the retracted position. In addition, a support 83 is provided under the stopper 82, which is supplied with an elastic force from an elastic member (not shown) to remain parallel with the longitudinal direction of the body 2.

In detail, the stopper 82 has a cross section having curves of different radii combined together and a step formed at the joint between the curves. When the earphone 6 is in the extended position, the step is supported by the support 83 so that the earphone 6 can stably maintain the extended position against an external force applied thereto.

The curves of the stopper 82 have a spiral shape. That is, the curves have the smallest radii where they abut the extender 7 and the largest radii at the step. This configuration serves to actuate a rotation detector 13 through the rotation of the stopper 82.

An extraction/retraction operator 86 is arranged along one side of the body 2, and an operator-side elastic member 87 is arranged next to the extraction/retraction operator 86 by which the user can operate the extraction/retraction operator 86.

A protrusion 84 is connected to the extraction/retraction operator 86, and has an elongated bar-like configuration extending to the inside of the body 2 to contact the support 83. In response to the operation of the extraction/retraction operator 86, the protrusion 84 acts to move the support 83.

A rotation detector 13 is arranged between the interior of the body 2 and the stopper 82 to control the power supply to the wireless headset 1 based on the extraction and/or retraction of the earphone 6.

According to such a structure, the stopper-side elastic member 85 constantly supplies a rotational force to the earphone 6 together with the extender 7 and the rotating shaft 81 connected to the earphone 6. The rotational force is directed parallel with the body 2, that is, along the direction of retraction of the earphone 6.

In a position where the user has completely extracted the earphone 6 from the storage position by applying an external force, the stopper 82 is supported by the support 83 and thus can stably maintain the extended position against any external force applied thereto.

The earphone 6 can be located stably at two positions through the interaction among the stopper 82, the stopper-side elastic member 85 and the support 83. In the first position, the wireless headset 1 is not being used. That is, the earphone 6 is placed collinear with the body and the extender 7 is completely retracted into the body. In the second position, the wireless headset 1 is being used. That is, the earphone 6 is completely extracted out and rotated to a position extending normal to the body.

In addition, where the earphone 6 is rotated to an intermediate position between the extended position and the retracted position, that is, to an angle smaller than 90° with respect to the body, the earphone 6 is constantly forced into the body by the stopper-side elastic member 85. In other words, the earphone 6 is forced toward a position collinear with the body.

According to the location guide structure for the earphone, the earphone 6 is not extracted owing to the interaction among the stopper 82, the stopper-side elastic member 85 and the support 83 unless the earphone 6 is completely extended under at least a specific amount of external force, at which point it becomes supported by the support 83.

As a result, this may advantageously prevent the earphone 6 from being extracted under external impact when the wireless headset 1 is contained in a pocket or bag. This structure may improve sanitary conditions and the convenience to the user of the earphone 6, and may improve the operational stability of the wireless headset 1.

The operation or function of the invention will be described in more detail with reference to the above-mentioned structure.

First, the storage position of the wireless headset 1 will be described in principle. Typically, the wireless headset 1 is carried by the user like a mobile phone, and preferably located in a position where the user can handle the headset 1 at any time. For this purpose, a clip 5 is provided on one side of the body 2 of the wireless headset 1, and fixed to the body 2 as a separate piece. The clip 5 has a shape extending from one end to the other of the body 2, and itself is flexible to a specific degree. Therefore, the user can easily hang the wireless headset 1 on a shirt pocket by using the clip 5. When using the wireless headset 1 to answer a call on the mobile phone, the user can readily take the wireless headset 1 out of a pocket.

Of course, the clip 5 shown in the drawings is merely one example, and can be provided in various forms. For example, the clip 5 may be provided integrally with the body 2.

The usage of the clip 5 is enhanced when the wireless headset 1 of this invention is bar-shaped. When the wireless headset 1 is shaped, for example, like a pen, the clip 5 can enable the wireless headset 1 to be hung on the pocket, thereby further improving the usage thereof.

Furthermore, in a storage position of the wireless headset 1, the earphone 6 is received into the body 2, and more particularly, supported by the body 2. Since the earphone 6 may be arranged along the longitudinal direction of the wireless headset 1, there is an advantage in that the earphone 6 does not interfere with external objects. Furthermore, even if the earphone 6 is caught by any external object, the earphone location guide structure stably supports the earphone 6 in position, thereby preventing it from being extracted outward. Due to such a stable structure, the operational stability of the wireless headset 1 is advantageously improved.

The process of using the wireless headset 1 will be described in more detail.

When using the wireless headset 1 to answer a call on the mobile phone, the user separates the clip 5 to pick up the wireless headset 1 and rotates the earphone 6 to extract it.

To describe the extraction process of the earphone in more detail, the user pushes the part of the earphone 6 protruding out of the body 2 with the same hand that is holding the body 2. This turns the earphone 6 about the rotating shaft 21, and when the earphone 6 has been rotated to an orientation perpendicular to the body 2, the earphone 6 is supported by the support 83. That is, the earphone 6 remains stationary in the extended position through the interaction between the stopper 82 and the support 83, even if an external force is applied thereto.

When the earphone 6 is completely extended and remains stationary, the rotation detector 13 on the inside wall of the body 2 is activated. To be specific, the stopper 82 has a helical shape with its longest radius at the portion adjacent to the extender 7. As a result, the portion having the longest radius (hereinafter referred to as “largest radius portion”) does not contact the rotation detector 13 when the earphone 6 is in the retracted position but contacts the rotation detector 13 when the earphone 6 is in the extended position. That is, when the earphone 6 is extracted, the interaction between the stopper 82 and the support 83 makes the earphone 6 remain stationary while activating the rotation detector 13 so that the wireless headset 1 starts operation.

To be specific, the rotation detector 13 may be provided with a switch, as shown in FIGS. 21 and 22, to detect the rotation of the stopper 82. When the earphone 6 is extended, the stopper 82 touches the switch installed in the rotation detector 13, and thus the wireless headset 1 is powered on to start operation. When the earphone 6 is retracted, the stopper 82 is separated from the switch of the rotation detector 13, and thus the wireless headset 1 is powered off to terminate operation. In this fashion, the operation of the wireless headset 1 can be controlled.

As an alternative, a sensor may be installed in the rotation detector 13 to detect the rotation of the stopper 82. That is, based on the sensor of the rotation detector 13 detecting the position of the earphone 6, the wireless headset 1 can be automatically turned on or off. For this purpose, various sensors may be installed and used, examples of which include a sensor for detecting the movement of the stopper 82 and the support 83 and a sensor installed inside the extender guide recess 9 to detect the movement of the extender 7. Such a sensor may be activated by detection of the rotation of the earphone 6 in the wireless headset 1, thereby further enhancing the usage of the wireless headset 1, where the earphone 6 is installed to be extended from and retracted into the wireless headset 1, while improving user convenience.

Now the process of terminating the operation of the wireless headset will be described in more detail.

To terminate the operation of the wireless headset 1 when the telephone call is finished, the earphone 6 is rotated so as to be retracted inward.

To describe the retracting process of the earphone 6 in more detail, the user manipulates the extraction/retraction operator 86 protruding from the body 2 using the same hand that is holding the body 2.

Preferably, the extraction/retraction operator 86 may be provided in the form of a button, which may be configured to return to its original position through the action of the operator-side elastic member 87, after being operated.

When the extraction/retraction operator 86 is pushed into the body 2, the protrusion 84 connected to the extraction/retraction operator 86 interacts with the support 83, thereby separating the support 83 from a point supporting the stopper 82. When the support 83 is separated from the supporting point, a force supporting the stopper 82 is removed, such that the earphone 6 returns to the retracted position under an elastic force from the stopper-side elastic member 83.

When the earphone 6 is retracted as above, the rotation detector 13 on the inside wall of the body 2 is activated. That is, as soon as the earphone 6 returns to the retracted position through the interaction between the stopper 82 and the support 83, the rotation detector 13 is activated, thereby automatically terminating the operation of the wireless headset 1. As described above, the rotation detector 13 may adopt a switch or a sensor.

As an alternative, when the user wishes to keep the wireless headset 1 attached to the ear even after the wireless headset 1 has been turned off, he/she may manually terminate the operation of the wireless headset by manipulating the on/off button 10.

The extraction/retraction process of the earphone will be apparent with reference to FIGS. 20 to 22.

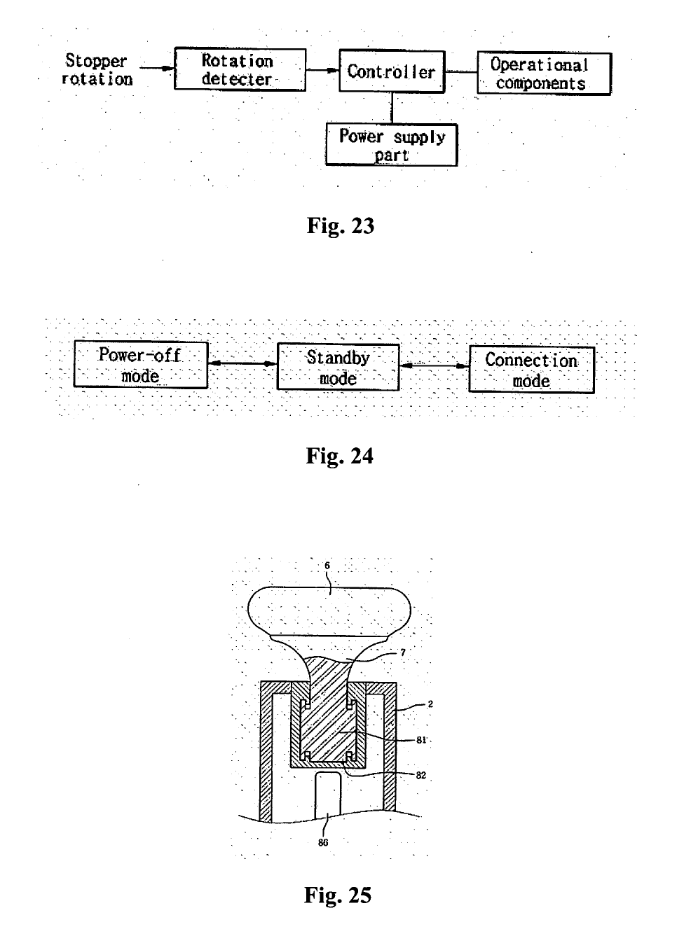

FIG. 23 is a block diagram illustrating a switch of the wireless headset according to the eighth embodiment of the invention.

With reference to FIG. 23, a process of controlling power through the manipulation of the earphone will be described as follows.

When the user attempts to use the wireless headset 1, he/she rotates the earphone 6 to extract it. On the other hand, to terminate the operation of the wireless headset 1, the user retracts the earphone 6 inward by rotating it.

To be specific, when the user completely extracts the earphone to use the wireless headset, the stopper is rotated to turn on the switch of the rotation detector or to activate the sensor of the rotation detector. Then, a signal is transmitted from the rotation detector to the controller.

In response to the signal transmitted to the controller, a power supply part operates to put the wireless headset into a connection mode. This also starts operational components of the wireless headset such as a microphone in charge of transmission, a speaker in charge of reception and a communication controller in charge of data transmission/reception to/from a Bluetooth main body.

When the user completely retracts the earphone to terminate the operation of the wireless headset, the stopper is rotated to separate from the switch of the rotation detector (OFF) or activate the sensor of the rotation detector. Then, a signal is transmitted from the rotation detector to the controller.

In response to the signal transferred to the controller, the power supply part operates to switch the wireless headset into a standby mode such that the wireless headset stops operation.

FIG. 24 is a block diagram illustrating the operational modes of the wireless headset according to the eighth embodiment of the invention.

With reference to FIG. 24, the operational modes of the wireless headset will be described as follows.

The operational modes of the wireless headset can be classified generally into three modes: power-off, standby and connection modes.

In the power-off mode, the operation of the wireless headset 1 is completely terminated and no power is consumed. This is similar to a mobile phone powered off.

While in the power off mode, if the on/off button 10 is held down for a certain amount of time, the wireless headset 1 enters the standby mode. The standby mode is similar to a standby mode of a mobile phone, and when the user extracts the earphone 6 or pushes the on/off button to use the wireless headset 1, the headset 1 immediately converts to the connection mode in which the wireless headset 1 is operating. In the standby mode, a minimal amount of power is consumed to maintain connection with a Bluetooth main body.

While in the standby mode, if the user extracts the earphone 6 or pushes the on/off button 10 to use the wireless headset 1, the headset 1 enters the connection mode. The connection mode is similar to a communicating status of the mobile phone, where the user can transmit/receive data such as audio signals by using the wireless headset 1. In the connection mode, all operational components of the wireless headset 1 such as a microphone in charge of transmission, a speaker in charge of reception and a communication controller in charge of data transmission/reception to or from the Bluetooth main body are activated.

Switching between the standby mode and the connection mode is enabled by the extraction/retraction of the earphone 6 or by the input of the on/off button.

As described in brief previously, the earphone 6 extends parallel to the longitudinal direction of the body 2 in the storage position. But, in the operating position, the earphone 6 is rotated to a right angle with respect to the longitudinal direction of the body 2. As a result, the distance between the earphone 6 and the body 2 is further increased, and interference between the ear of the user and the body 2 is advantageously reduced.

Although not described in detail, any electrical connector structure such as an FPCB may of course be provided to connect the earphone 6 with the board 12 in order to transmit electrical signals to the earphone 6.

The microphone 3 is arranged in the lower part of the wireless headset 1, which is closest to the mouth of the user, in order to effectively sense the user's voice.

According to this embodiment of the invention, the earphone 6 is arranged at one end of the wireless headset 1, and configured to extend along the longitudinal direction of the headset 1 and rotate to be folded about the headset 1. This results in merits of improved structural convenience. Furthermore, since the earphone 6 is not installed inside the wireless headset 1, there are merits of improving convenience in the installation of internal components of the body 2 and promoting the spatial efficiency thereof, thereby enabling the miniaturization of the wireless headset 1. Furthermore, the earphone 6 protruding from the body 2 can be easily extended from and retracted into the body 2. As additional merits, the wireless headset 1 can be further reduced in size and have a slim and compact shape. Moreover, since it is possible to automatically control power supplied to the wireless headset 6 through the extraction/retraction of the earphone 6, the user can more simply and easily use the wireless headset 6.

### Embodiment 9

This embodiment of the invention is substantially the same as the eighth embodiment except that a location guide structure for the earphone has different features. Accordingly, the same parts will not be described but can be understood with reference to the eighth embodiment. In the drawings, the same reference numerals are used to designate like elements throughout.

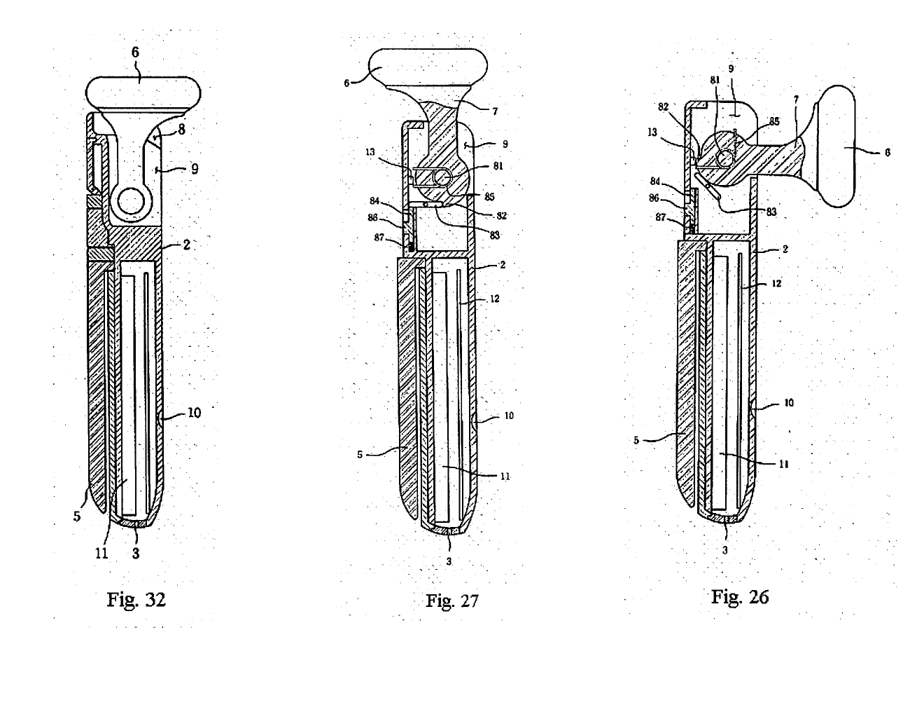

FIGS. 25 to 27 are vertical cross-sectional views illustrating the wireless headset according to the ninth embodiment of the invention.

Referring to FIGS. 25 to 27, the earphone location guide structure of this embodiment is opposite to that of the eighth embodiment. That is, the restoring force provided by the stopper-side elastic member 85, which provides an elastic force to the earphone 6, tends to extract the earphone 6 rather than retract it.

That is, the earphone 6 of this embodiment is supported by the support 83 while in the retracted position, but is returned to the extended position by the stopper-side elastic member 85 in response to the extraction/retraction operator 86.

To describe the process of extracting the earphone 6 to use the wireless headset 1, the user manipulates the extraction/retraction operator 86 arranged in the exterior of the body 2 with the same hand that is holding the body 2.

Preferably, the extraction/retraction operator 86 may be provided in the form of a button, which may be configured to return to its original position after being operated, through the action of the operator-side elastic member 87.

When the extraction/retraction operator 86 is pushed toward an upper part of the body 2, the protrusion 84 connected to the extraction/retraction operator 86 interacts with the support 83, thereby separating the support 83 from a point supporting the stopper 82. With this operation, a force supporting the stopper 82 is removed, such that the earphone 6 returns to the extended position under an elastic force from the stopper-side elastic member 83.

Likewise to the eighth embodiment, as soon as the earphone 6 is extracted, the rotation detector 13 on the inside wall of the body 2 is activated. That is, simultaneous with the earphone 6 being extracted, the rotation detector 13 is operated, thereby activating the wireless headset 1.

Likewise to the eighth embodiment, when the earphone 6 is completely extended, the rotation detector 13 on the inside wall of the body 2 is activated. That is, the rotation detector 13 activates through contact with the largest radius portion of the stopper 82, thereby starting the operation of the wireless headset 1. Here, the rotation detector 13 may adopt a switch, a sensor or the like.

Now the process of terminating the operation of the wireless headset 1 will be described in more detail.

To terminate the operation of the wireless headset 1 when the telephone call is finished, the user rotates the earphone 6 to retract it inward.

That is, when the user pushes a part of the earphone 6 with the hand that is holding the body 2, the earphone 6 is rotated about the rotating shaft 81. When pushed into a position parallel with the body 6, the earphone 6 is supported by the support 83. In other words, through the interaction between the stopper 82 and the support 83, the earphone 6 can be stably maintained in the retracted position against an external force applied thereto.

Similar to the eighth embodiment, when the earphone 6 is completely retracted into a stationary position, the rotation detector 13 on the inside wall of the body 2 is activated. That is, the earphone 6, upon being retracted, remains stationary in that position due to the interaction between the stopper 82 and the support 83, and at the same time, the rotation detector 13 is activated to automatically terminate the operation of the wireless headset 1.

Such a structure of the wireless headset 1 is expected to be useful when it is attached to a user such as a driver who uses both hands. Since the restoring force provided by the stopper-side elastic member 85 tends to extract the earphone 6 rather than retract it, the earphone 6 can return to the extended position even after being rotated inwards to a certain degree under an external force applied thereto, except in the case where the earphone 6 is rotated to the fully retracted position and fixed by the support 83.

### Embodiment 10

This embodiment of the invention is substantially the same as the eighth embodiment except for the direction of the rotation of the earphone 6 and the rotation status of the earphone 6. Accordingly, the same parts will not be described but can be understood with reference to the eighth embodiment. In the drawings, the same reference numerals are used to designate like elements throughout.

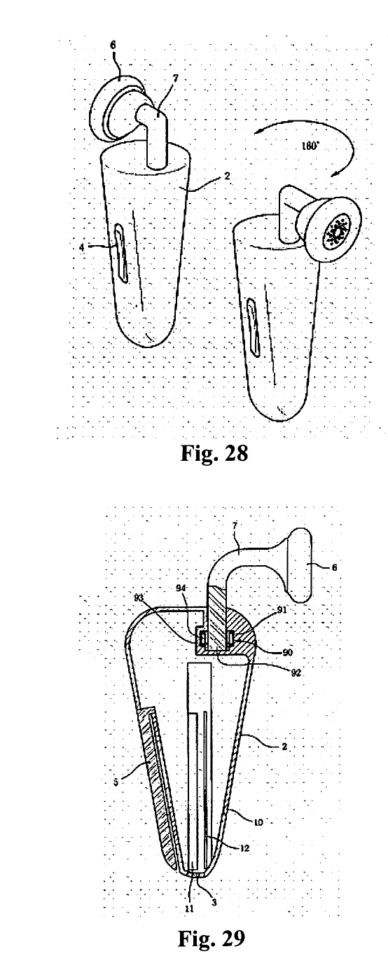

FIG. 28 is a perspective view illustrating the wireless headset according to the tenth embodiment of the invention, and FIG. 29 is a vertical cross-sectional view illustrating the wireless headset according to the tenth embodiment of the invention.

Referring to FIGS. 28 and 29, the wireless headset of this embodiment is substantially the same as the eighth embodiment in that the earphone 6 protrudes from the upper end of the wireless headset. However, the earphone 6 of this embodiment rotates in a plane perpendicular to the longitudinal direction of the wireless headset. This rotation plane is formed in the horizontal direction of FIG. 29. To achieve this operational feature, the body 2 is provided with a recess formed in a horizontal direction (along the rotation plane) and a rotating shaft 73 mounted vertically in the recess and parallel to the longitudinal direction of the wireless headset.

The earphone location guide structure provided at a joint between the extender 7 and the body 2 is similar to a hinge structure for rotating a flip-phone. The earphone location guide structure has an elastic hinge 90 at a joint between the extender 7 and the body 2.

The structure of the elastic hinge 90 will now be described in detail. The elastic hinge 90 of this embodiment includes a hinge body 91 forming an outside case, elastic members 94 loaded on the inside walls of the hinge body 91, a rotation guide 93 having a polygonal cross section and inserted between the elastic members 94, and a rotating shaft 92 for rotating through the same angle as the rotation guide 93 and the extender 7.

With this structure, the earphone 6 can be rotated horizontally through 360°. That is, when the earphone 6 is rotated, the rotating shaft 92 and the rotation guide 93 rotate together. The rotation of the rotation guide 93 is controlled by the elastic members 94. That is, since the rotation guide 93 is provided with a polygonal cross section including at least one plane, the elastic members 94 allow the rotating shaft 92 to rotate to an angle corresponding to the plane of the rotation guide 93. In such an operational structure, the plane may be preferably formed on the rotation guide 93 in a position opposed to the elastic members 94 when the earphone 6 is completely extended and in a position opposed to the elastic members 94 when the earphone 6 is completely retracted.

With this construction, the earphone 6 can be rotated horizontally for 360°, and the user can use the wireless headset by fixing the earphone 6 in a desired position.

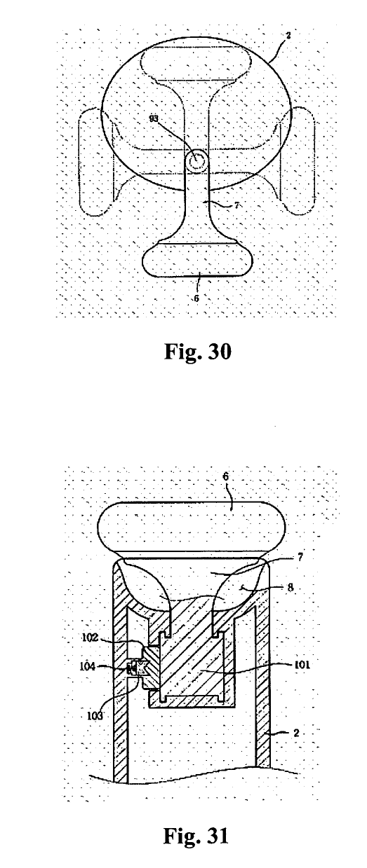

FIG. 30 is a plan view of the wireless headset according to the tenth embodiment of the invention, explaining the range of rotation of the earphone 6. Referring to FIG. 30, wherein the earphone 6 is completely rotated toward the inside of the body, that is, the extender 7 is aligned in parallel with the longitudinal direction of the body 2 and the earphone 6 is placed inside the outline of the body 2 (in the plan view), it can be understood that the wireless headset is in a storage position.

On the other hand, where the earphone 6 is completely rotated outward from the body, that is, the extender 7 is aligned normal to (?) the longitudinal direction of the body 2 and the earphone 6 is placed outside the outline of the body (in plan view), it can be understood that the wireless headset is in use. This is because when the earphone 6 is completely rotated outward from the body, the extender 7 is located farthest from the body 2, so that there is no fear that the body 2 could touch the ear of the user.

With reference to the above structure, the operation and function of this embodiment will be described in more detail.

First, the process of using the wireless headset 1 will be described. The user horizontally rotates the earphone 6 and/or extender 7, which protrude upward from the body 2 and are directed toward the inside of the body, with a hand in order to use the headset 1. Then, the earphone 6 is rotated about the rotating shaft 83, and when rotated completely outward from the body 2, is kept stationary by the elastic hinge 90.

In the meantime, when the earphone 6 is rotated completely outward from the body 2 as above, the rotation detector 13 mounted on the elastic hinge 90 is activated. That is, when the earphone 6 is rotated completely outward from the body 2, the earphone 6 is fixed in position by the elastic hinge 90, and the rotation detector 13 is activated to start the operation of the wireless headset 1.

Likewise to the eighth and ninth embodiments, various sensors may be preferably installed and used. Examples of such sensors may include a sensor for detecting the movement of the rotating shaft 92 and the rotation guide 93 to activate the rotation detector 13 in response to the motion of the elastic hinge 90, or a sensor installed inside the extender guide recess 9 to detect the movement of the extender 7. Such a sensor may be activated by detection of the rotation of the earphone 6 in the wireless headset 1, thereby further enhancing the usage of the wireless headset 1, where the earphone 6 is installed so as to be extended from and retracted into the headset 1, while improving the convenience to the user. By using such a sensor, it is possible to control the power supplied to the wireless headset merely through the rotation of the earphone 6, thereby improving the ease of use of the wireless headset 1 and the convenience to the user.

Now the process of terminating the operation of the wireless headset will be described in more detail.

To terminate the operation of the wireless headset 1, the user horizontally rotates the earphone 6 and/or extender 7, which protrude upward and are directed outward from the body 2, with a hand. Then, the earphone 6 is rotated about the rotating shaft 83. When the user rotates the earphone 6 completely toward the inside of the body 2, the earphone 6 remains stationary through the action of the elastic hinge 90.

When the earphone 6 is rotated completely toward the inside of the body 2, the earphone 6 is fixed in position by the elastic hinge 90, and at the same time, the rotation detector 13 is activated to terminate the operation of the wireless headset 1.

As an alternative, when the user wishes to keep the wireless headset 1 attached to the ear even after the wireless headset 1 has been turned off, he/she may manually terminate the operation of the wireless headset by manipulating the on/off button 10.

In this embodiment also, as an advantageous effect, according to the rotation angle of the earphone 6, the earphone 6 can remain fixed in stationary positions until a certain amount of external force is applied. Furthermore, since the earphone 6 is placed inside the outline of the body 2 in the plan view, when the earphone 6 is rotated completely toward the inside of the body 2, an external object rarely contacts the earphone 6 and thus the wireless headset can be easily carried and stored. In addition, since the earphone 6 protrudes from one end of the body 2, the user can conveniently operate the wireless headset with one hand without any difficulty in carrying or storage.

### Embodiment 11

FIG. 31 is a cross-sectional view of a wireless headset according to the eleventh embodiment of the invention, taken along the line II-II′ of FIG. 1, and FIG. 32 is a cross-sectional view of the wireless headset according to the eleventh embodiment of the invention, taken along the line I-I′ of FIG. 1.

As a characteristic feature of the wireless headset 1 of this embodiment, the earphone 6 can be moved easily, and a construction associated therewith will now be described in detail.

A bar-shaped extender 7 is arranged at a joint between the earphone 6 and the body 2 to provide a gap of a certain distance between the earphone 6 and the body 2. The body 2 has an earphone guide recess 8 for guiding the location of the earphone 6 and an extender guide recess 9 for guiding the location of the extender 7.

The earphone 6 is rotated with respect to the body 2 to a position as shown in FIG. 6. In this position, the center line C2 of the earphone 6 is tilted with respect to the extension line C1 of the upper surface of the body 2. The angle A between the extension line C1 and the center line C2 is in the range from 5° to 20°, and preferably from 10° to 15°. When the earphone 6 has been rotated about the body 2 and fixed in place, the offset B between the underside of the earphone 6 and the upper surface of the body 2 is about 2 mm to 8 mm, and preferably 4 mm to 5 mm.

In detail, when the earphone 6 is extracted outward from the wireless headset 1 to be inserted into the ear of the user during the use of the wireless headset 1, the extender 7 serves to prevent the earphone 6 from being caught by the ear of the user, which would obstruct the insertion of the earphone 6. That is, the extender 7 maintains a specific gap between the ear of the user and the body 2 when the wireless headset 1 is hung on the ear of the user.

To be specific, the earphone guide recess 8 is depressed into the body 2 along a large width from the end thereof to provide a seating space for the earphone 6 which is retracted to a position adjacent to the body 2 in a storage position of the wireless headset 1.

In addition, the extender guide recess 9 serves to guide the movement of the extender 7 while the earphone 6 is being extracted from the body 2 for the use of the wireless headset 1 or after the earphone has been extracted.

Now a more detailed description will be made of a rotating shaft, a flexible portion and a rotation stopper which serve to guide the location of the earphone 6, fix the position of the rotating shaft during the operation of the earphone 6, and prevent the rotation of the rotating shaft against an external force of a preset amount or less.

First, a rotating shaft 101 is arranged at the lower end of the extender 7, extending perpendicular to the longitudinal direction of the extender 7, a flexible portion 102 is arranged at one end of the rotating shaft 101, a rotation stopper 103 contacts the flexible portion 102, and an elastic member 104 is further connected to the end of the rotation stopper 103.

With this structure, the rotation stopper 103 is constantly provided with a force imparted to the flexible portion 102 from the elastic member 104. The rotation stopper 103 applies a force to the flexible portion 102 to cause it to remain at a predetermined rotation angle while constantly contacting the flexible portion 102.

To describe in detail, this embodiment provides a similar structure to a ballpoint pen. That is, the flexible portion 102 has alternating protrusions and indentations, and the rotation stopper 103 has a shape conforming to the protrusions—and indentations of the flexible portion 102. Therefore, when the earphone 6 is rotated around the rotating shaft 101, the rotation stopper 103 moves along the flexible portion pitch-by-pitch from one indentation to the next.

To describe the operation of this embodiment, in a position where the flexible portion 102 is aligned with the rotation stopper 103, the rotation stopper 103 resists the rotation of the flexible portion 102. This as a result restrains the flexible portion 102 against an external force unless it is greater than a specific amount. In this position, when the earphone 6 is rotated in an extracting or retracting direction under an external force exceeding this specific amount, the rotating shaft 101 and the flexible portion 102 are rotated together with the earphone 6 in a stepwise fashion, in particular, by the pitch spacing of the indentation pattern of the flexible portion 102 in each step.

In other words, the protrusions of the flexible portion 102 and the indentations of the rotation stopper 103 are aligned with each other only when they are meshed. In addition, the angle of the rotation of the earphone 6 is varied according to the amount of rotation of the flexible portion. According to such a structure, various stationary positions of the earphone 6 can be provided. This can be more positively applied to a situation where the user wants to attach the earphone 6 to his/her ear in various positions.

The processes of starting and terminating the operation of the wireless headset 1 will be described in more detail.

In the case of using the wireless headset 1 to answer a call on the mobile phone, the user holds the wireless headset 1 and rotates the earphone 6 to extract it. That is, when the user pushes the part of the earphone 6 protruding out of the earphone guide recess 8 while continuously applying a specific amount of external force thereto, the earphone 6 rotates about the rotating shaft 101 through the interaction among the flexible portion 102, the rotation stopper 103 and the elastic member 104. Here, the earphone 6 performs stepwise rotation by a specific angle at each step.

Once the earphone 6 is extended, the earphone 6 remains stationary at the extended position under the force acting among the flexible portion 102, the rotation stopper 103 and the elastic member 104 until the user retracts the earphone 6 inward with a force opposite to that used during extraction. Thus, the earphone 6 can remain correctly at the extended position without movement when inserted into the ear. As a result, the earphone 6 can be inserted into the ear more precisely and conveniently.

When attempting to retract the earphone 6 inward when the wireless headset 1 is not in use, the earphone 6 is rotated inward. In order to retract the earphone 6 inward when the operation of the wireless headset 1 is terminated, the user merely rotates the earphone 6 inward. This operation is the reverse of the extraction operation, and thus a detailed description thereof will be omitted.

When the earphone 6 is completely extended, the user can push the on/off button 10 to activate the wireless headset 1. After the call, the user can push the on/off button 10 again to terminate the operation of the wireless headset 1.

Alternatively and preferably, the headset 1 includes a rotation detector 13 inside the body 2. The rotation detector 13 detects the extraction and retraction of the earphone 6 so that the headset 1 starts or terminates operation. For this purpose, various sensors may be installed and used, examples of which include a sensor for detecting the movement of the flexible portion 102 and/or the rotation stopper 103, and a sensor installed inside the extender guide recess 9 to detect the movement of the extender 7. Such a sensor may be activated by detection of the rotation of the earphone 6 in the wireless headset 1, thereby further enhancing the ease of use of the wireless headset 1, where the earphone 6 is installed to be extended from and retracted into the wireless headset 1, while improving user convenience.

As explained briefly in the above description, the earphone 6 in the storage position extends along the longitudinal direction of the body 2. On the other hand, in the operating position, the earphone 6 is at an angle with respect to the longitudinal direction of the body 2 that is, rotated away from the body 2. Then, the earphone 6 is moved farther away from the body 2, and as an advantageous result, the interference between the user's ear and the body 2 is further reduced.

While not described in detail, any electrical connector structure such as an FPCB may of course be provided to connect the earphone 6 with the board 12 in order to transmit electric signals to the earphone 6.

The microphone 3 is arranged in the lower part of the wireless headset 1, which is closest to the mouth of the user, in order to effectively sense the user's voice.

According to this embodiment of the invention, the earphone 6 is configured to extend from one end of the wireless headset 1 along the longitudinal direction of the headset 1 and to rotate about the headset 1. This results in merits of improved structural convenience. Furthermore, since the earphone 6 is not installed inside of the wireless headset 1, there are merits of improving convenience in the installation of internal components of the body 2 and promoting the spatial efficiency thereof. There are other merits of enabling the miniaturization of the wireless headset 1 while facilitating the portability and storage thereof. Moreover, since the power supplied to the wireless headset 6 is automatically controlled merely through the extraction and retraction of the earphone 6, the user can more simply and easily use the wireless headset 6.

### Embodiment 12

This embodiment of the invention is substantially the same as the eleventh embodiment except that a location guide structure for the earphone has different features. Accordingly, the same parts will not be described but can be understood with reference to the eleventh embodiment. In the drawings, the same reference numerals are used to designate like elements throughout.

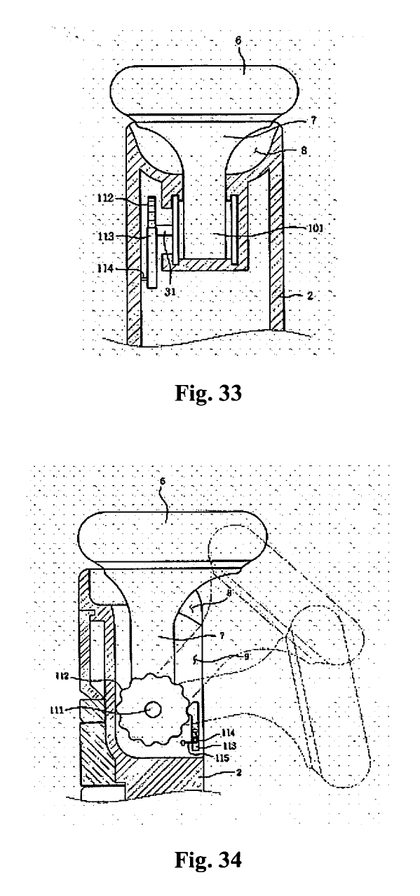

FIGS. 33 and 34 are vertical cross-sectional views illustrating a wireless headset according to a twelfth embodiment of the invention, in which the cross section of the wireless headset is cut at the same angle as in FIGS. 31 and 32.

Referring to FIGS. 33 and 34, the earphone location guide structure of this embodiment is similar to a gear and a ratchet, including a rotating portion, a flexible portion and a rotation stopper. That is, the earphone locating guide structure includes a rotating shaft 111 arranged at the lower end of the extender 7, a gear 112 arranged at one end of the rotating shaft 111 to rotate coaxially with the rotating shaft 111, a ratchet 113 meshed with the gear 112 to control the rotation of the gear 112, a ratchet shaft 114 supporting the ratchet 113, and a ratchet-side elastic member 115 for applying an elastic force that tends to rotate the ratchet 113 around the ratchet shaft 114.

To describe in detail, the rotating shaft 111 and the gear 112 are parts that rotate coaxially, and the gear 112 is composed of a number of projections and indentations which are inclined smoothly. The ratchet 113 is shaped to mesh into the indentations of the gear 112, and placed to be parallel with the longitudinal direction of the body 2. The ratchet shaft 114 and the ratchet-side elastic member 115 apply a specific elastic force to the ratchet 113 to maintain this position.

According to the above described structure, the ratchet elastic member 115 constantly provides the ratchet 113 with a centripetal force directed toward the center of the gear 112, and the ratchet 113 keeps contacting the gear 112 while forcing the gear to be oriented at a specific rotation angle.

To describe the operation of this embodiment, where the ratchet 113 is meshed into the indentations of the gear 112, the ratchet 113 resists the rotation of the gear 112 or less. The gear 112 is restrained from rotating unless an external force is applied that is greater than a specific amount. In this position, when the earphone 6 is rotated to be extracted or retracted under an external force exceeding the specific amount, the rotating shaft 111 and the gear 112 are rotated along with the earphone 6 in a stepwise fashion, in particular, by one pitch of the gear 112 at each step.

In other words, according to this embodiment, stationary positions are stabilized whenever an indentation of the gear 112 is aligned with the ratchet 113 during the rotation of the gear 112. This as a result produces various stationary positions. Thus, the user can select various earphone positions according to his or her preference.

Likewise to the eleventh embodiment, a rotation detector 13 for detecting the retracted position of the earphone 6 may be arranged inside the body 2. With the rotation detector 13, the wireless headset 1 can be automatically turned on and/or off, thereby enhancing the convenience to the user.

### Embodiment 13

This embodiment of the invention is substantially the same as the eleventh embodiment except that a location guide structure for the earphone has different features. Accordingly, the same parts will not be described but can be understood with reference to the eleventh embodiment. In the drawings, the same reference numerals are used to designate like elements throughout.

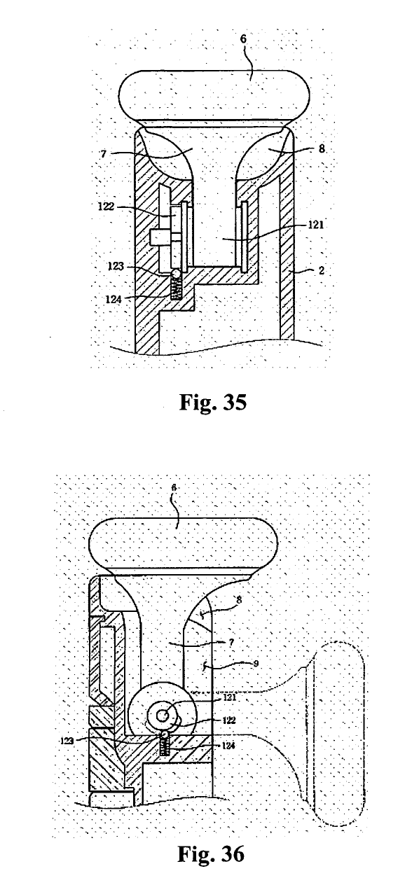

FIGS. 35 and 36 are vertical cross-sectional views illustrating a wireless headset according to a thirteenth embodiment of the invention, in which the cross section of the wireless headset is cut at the same angle as in FIGS. 31 and 32.

Referring to FIGS. 35 and 36, the earphone location guide structure of this embodiment includes a rotating shaft 121 arranged at the lower end of the extender 7 perpendicular to the longitudinal direction of the extender 7, a flexible portion 122 arranged at one side of the rotating shaft 121 to rotate coaxially with the rotating shaft 121, a rotation stopper 123 interacting with the flexible portion 122 to control the rotation of the flexible portion 122, and an elastic member 124 connected to the rotation stopper 123.

To describe in detail, this structure is similar to a cam, in which the elastic member 124 constantly imparts an upward force to the rotation stopper 123, and the upper end of the rotation stopper 123 forces the flexible portion 122 into a specific rotation angle while staying in constant contact with the same. Then, in response to the rotation of the earphone 6, the flexible portion 122 is rotated via the rotating shaft 121. The flexible portion 122 is shaped similar to a non-circular cam, but has two indentations. The flexible portion 122 is pushed upward by the rotation stopper 123 to provide a force enabling the earphone to move to a predetermined position.

The earphone 6 remains stable through the interaction between the flexible portion 122 and the rotation stopper 123 in specific positions. In one position, the earphone 6 is received into the earphone guide recess 8 with the wireless headset 1 not in use. In another position, the earphone 6 is extracted out completely with the wireless headset 1 in use. In an intermediate position, the flexible portion 122 is unstably placed and thus provides a force to rotate in either direction.

Now the operation of the wireless headset 1 of this embodiment will described in detail.

When the user attempts to use the wireless headset 1, he/she rotates the earphone 6 to extract it. To describe this process in more detail, the user pushes the part of the earphone 6 that protrudes from the earphone guide recess 8 with the hand holding the body 2. This rotates the earphone 6 about the rotating shaft 121, extracting the earphone 6 through the interaction between the flexible portion 122 and the rotation stopper 123.

Since the earphone 6 can be extracted out swiftly and simply as above when the user additionally applies a specific amount of external force, there is an advantage in that the convenience to the user can be further improved. Once extracted, the earphone 6 remains stationary in the extended position under a force acting between the flexible portion 122 and the rotation stopper 123, until the user pushes the earphone 6 inward with a force opposite to that exerted for the extraction of the earphone 6.

With this structure, the user can easily carry the earphone 6 and stably use the headset 1 regardless of a certain amount of external force being unintentionally applied to the wireless headset during the operation of the earphone 6.

Similar to the eleventh embodiment, a rotation detector 13 for detecting the retracted position of the earphone 6 may be arranged inside the body 2. With the rotation detector 13, the wireless headset 1 can be automatically turned on/off, thereby enhancing the convenience to the user.

### Embodiment 14

This embodiment of the invention is substantially the same as the thirteenth embodiment except that a location guide structure for the earphone has different features. Accordingly, the same parts will not be described but can be understood with reference to the thirteenth embodiment. In the drawings, the same reference numerals are used to designate like elements throughout.

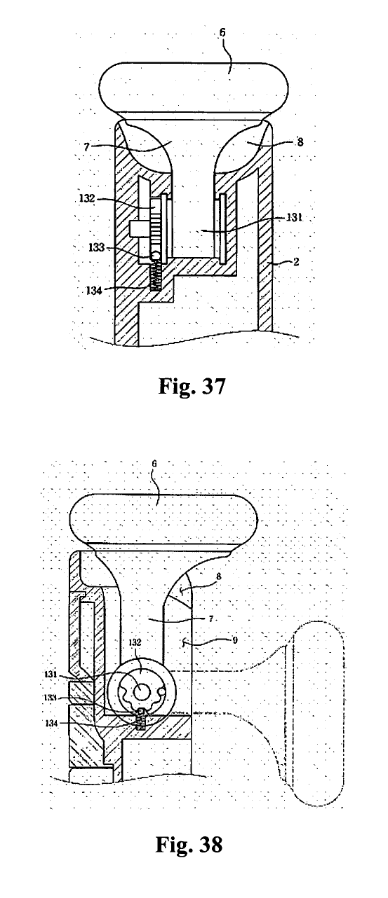

FIGS. 37 and 38 are vertical cross-sectional views illustrating a wireless headset according to a fourteenth embodiment of the invention, in which the cross section of the wireless headset is cut at the same angle as in FIGS. 35 and 36.

Referring to FIGS. 37 and 38, the earphone location guide structure of this embodiment includes a rotating shaft 131 arranged at the lower end of the extender 7, a flexible portion 132 arranged at one side of the rotating shaft 131 to rotate coaxially with the rotating shaft 131, a rotation stopper 133 for interacting with the flexible portion 132 to control the rotation of the flexible portion 132, and an elastic member 134 connected to the rotation stopper 133.

Now the construction and operation of this embodiment will be described in detail with an emphasis on the flexible portion 132 which shows different features from the thirteenth embodiment.

The flexible portion 132 can be understood as a combination of the gear structure of the twelfth embodiment and the cam structure with two indentations of the thirteenth embodiment. That is, the flexible portion 132 is shaped similarly to a non-circular cam, in which indentations are formed with a uniform pitch in an area of the flexible portion 132 corresponding to the range of rotation of the earphone 6. Two outermost indentations placed at each end correspond to positions where the earphone 6 is extended and retracted completely in the range of rotation of the earphone 6. The outermost indentations are more deeply depressed than the other indentations in order to positively lock the extended and retracted positions.

Other than the flexible portion 132, other components of this embodiment which include the rotating shaft 131, the rotation stopper 133 and the elastic member 134 have the same structure and function as the foregoing thirteenth embodiment. That is, the elastic member 124 constantly imparts an upward force to the rotation stopper 123, and the upper end of the rotation stopper 123 forces the flexible portion 122 into a specific rotation angle while constantly contacting the same. Then, in response to the rotation of the earphone 6, the flexible portion 122 is rotated via the rotating shaft 121. The flexible portion 122 is shaped similarly to a non-circular cam, but has two indentations. The flexible portion 122 is pushed upward by the rotation stopper 123 to provide a force enabling the earphone to move to a predetermined position.

To describe the operation of this embodiment, in a position where the flexible portion 132 is meshed with the rotation stopper 133, the rotation stopper 133 resists the rotation of the flexible portion 132 so that the flexible portion 132 is restrained from rotating unless an external force greater than a specific amount is applied thereto. When the earphone 6 is rotated from this position toward the extended or retracted position under an external force exceeding the specific amount, the rotating shaft 131 and the flexible portion 132 are rotated in a stepwise fashion, in particular, by one pitch of the gear 112 at each step.

Since the angle of rotation of the earphone 6 can vary according to the position of the flexible portion 132 meshing with the rotation stopper 133, more stationary positions of the earphone 6 can be provided and the earphone 6 can remain stationary in various positions. Accordingly, the user can select various desirable positions, which are supported by the flexible portion 132 and the rotation stopper 133. As a result, more stable usage can be enabled.

According to the present invention as described herein, the wireless headset can operate stably and normally while remaining stably at a designated position with a given structure even under an accidental external impact applied thereto.

In addition, the wireless headset is reduced in size and manufacturing cost and the inner space of the wireless headset can be utilized more efficiently.

Furthermore, the wireless headset can be easily carried, and the user can more easily use the wireless headset by manipulating the earphone with the fingers of the hand that is holding the bar-shaped body.

Moreover, power supplied to the wireless headset is controlled through the extraction/retraction of the earphone, such that the wireless headset can be used more easily, conveniently and promptly.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A wireless headset equipped a set of electric circuits for receiving, amplifying and reproducing electric signals, a volume controller, a micro phone, on-off switch and a battery charger comprising:
a main body (2),
an earphone (6) rotatably attached to a proximal end of the main body (2),
an extender (7) for protruding out said earphone (6) with a proper length from the main body (2) to be wear by a user. and
an earphone position guidance (8) for stably maintaining said earphone (6) on a selected position with respect to the main body (2) by setting either one of a retracting position, extracting position or intermediate position.

2. A wireless headset according to claim 1, wherein said main body (2) has elongated bar-shape, and said earphone position guidance (8) consisted of an elastic hinge is attached between the main body (2) and earphone (6) for guiding the rotation of the earphone from top to lateral of the main body (2).

3. A wireless headset according to claim 1, wherein said earphone (6) is snapped into the earphone position guidance (8) by pressing from outside while a head portion of said earphone is exposed outside of said earphone position guidance (8), said earphone (6) is vertically or horizontally popped out with respect to a longitudinal direction of the main body (2) and the extender (7) snapped into an extender compartment (9).

4. A wireless headset according to claim 1, wherein said earphone is tilted 5° to 20° with respect to an extension line (C1) of the main body to a center line of the earphone (C2) and said earphone has an offset of 2 mm to 8 mm between a top surface of the main body and a bottom surface of the earphone when the earphone is rotatably popped-out from the main body to the stationary position.

5. A wireless headset according to claim 1, further comprising a flexible portion connected the earphone to the main body for elastically deforming.

6. A wireless headset according to claim 1, further comprising:
the main body (2) forming bar-shape,
the earphone (6) placed in a recessed area of the main body (2),
said extender (7) to protrude out the earphone (6) from the main body (2) with a proper length at the extracted position suitable for wearing by a user,
the earphone guidance (8) formed a recessed area in the main body (2) for guiding to pop-out by pressing outside, and snapping-in to rest the earphone (6),
an elastic hinge disposed at an axis (21) of the earphone (6) for exerting an elastic force to a rotating position of the earphone (6), thereby the earphone is kept stationary in an extracting position, and
a clip coupled to the main body for hanging on the user's pocket.

7. A wireless headset according to claim 6, wherein said elastic hinge is further comprised of:
a rotating shaft (21) at the axis of the earphone (6),
a cam (22) coaxially rotating with respect to the rotating shaft,
a stud (23) for contacting with said cam (22), and
an elastic member (24) for exerting elastic force to said stud (23).

8. A wireless headset according to claim 1, further comprising:
the earphone (6), which is rotatably attached to the main body (2), being designed to be foldable in a direction with respect to the main body (2),
the earphone guidance (8) formed a recessed area in the main body (2) for resting the earphone (6) and guiding to pop-out the earphone (6) by pressing outside,
the extender (7) to protrude out the earphone (6) from the main body (2) with a proper length at the extracted position suitable for wearing by a user,
a rotating shaft (21) at an axis (51) of the extender (7) end,
a rotating guidance (52) to rotate together with the rotating shaft (51), said rotating guide (52) formed a polyhedral shape to have contacting plan surfaces, and
an elastic member (53) for exerting resilient force to the contacting plan surface of the rotating guidance (52) for stably holding the portion of the earphone (6).

9. A wireless headset according to claim 8, wherein said elastic member (53) made of resin material is integrally assembled with the main body (2).

10. A wireless headset according to claim 1, further comprising:
the earphone (6), which is rotatably attached to the main body (2), being designed to be foldable in a direction with respect to the main body (2),
the extender (7) to protrude out the earphone (6) from the main body (2) with a proper length at the extracted position suitable for wearing by a user,
the earphone guidance (8) formed a recessed area in the main body (2) for resting the earphone (6) and guiding to pop-out the earphone (6) by pressing outside,
a rotating shaft (41) at an axis (41) of the extender (7) end,
a rotating guide plate (42) for rotating equiangular distance along with the rotating shaft (41),
a multiple of stoppers (45) disposed at equal radial distant from a center of the rotating guide plate (42),
a detent (44) for selectively latching the stopper (45), and
an elastic member (43) for exerting elastic force to the detent (44) to stably hold the rotating guide plate (42).

11. A wireless headset according to claim 10, wherein said stoppers (45) are arranged in the positions corresponding to the extracting position, retracting position and intermediate position of the earphone (6).

12. A wireless headset according to claim 1, further comprising:
the earphone (6), which is rotatably attached to the main body (2), being designed to be foldable in a direction with respect to the main body (2),
the earphone guidance (8) formed a recessed area in the main body (2) for resting the earphone (6) and guiding to pop-out the earphone (6) by pressing outside, and
the extender (7) for protruding out the earphone (6) from the main body (2) with a proper length at the extracted position, said extender (7) including a flexible portion (61) located between the head and root of the earphone (6), which is formed by double injection molding process, said flexible portion (61) made of a soft elastic material for smoothly bending while it is extracting out, so that the earphone (6) will be suitable to wear by the user.

13. A wireless headset according to claim 12, further comprising a compartment of the main body (2) for housing the flexible portion (61) of earphone (6) has formed a constricted portion (62) looks like a neck for locking the extender (7) to maintain the earphone (6) at the extracted position when the earphone is popped out.

14. A wireless headset equipped a set of electric circuits for receiving, amplifying and reproducing electric signals, a volume controller, a micro phone, on-off switch and a battery charger comprising:
a main body (2) forming elongated bar-shape,
an earphone (6) rotatably attached perpendicular to a longitudinal line of the main body (2),
an extender (7) for protruding out said earphone (6) with a proper length from the main body (2) suitable to be wore by a user, and
an earphone rotating guidance (75) for guiding and stably maintaining said earphone (6) on a selected position with respect to the main body (2).

15. A wireless headset according to claim 14, wherein said earphone rotating guidance (75) comprising an elastic hinge (71), hinge housing (72), a shaft (73) and an elastic member (74) for guiding the rotation of earphone (6) in a range of 180° and to maintain a selected location at the extracted position.

16. A wireless headset according to claim 14, wherein said earphone rotating guidance (75) further comprising a corner cutout for housing the earphone (6), so that the earphone (6) folded into a direction of the corner cutout housing when it is not in use, and an earphone positioning guidance maintaining the earphone stationary at the extracted position when it is in use.

17. A wireless headset according to claim 1, further comprising:
a Bluetooth module has mounted in the main body (2),
the earphone (6) enabling to snap into a recessed area of the main body (2), while a head portion of said earphone is partially exposed outside of the main body (2),
an earphone position guidance for keeping the earphone (6) stationary with respect to the main body (2) at the extracting and retracting position, said earphone position guidance supporting the earphone (6) and preventing excessive rotation of the earphone (6).

18. A wireless headset according to claim 1, further comprising:
said earphone (6) rotatably extracted from top to lateral with respect to a longitudinal direction of the main body (2),
an earphone actuating unit (86) for operating the earphone along with the earphone positioning guidance according to the selected position of extracting/retracting,
a rotating detector (13) for detecting the rotating position of the earphone (6) to control power supplying to the wireless headset.

19. A wireless headset according to claim 18, wherein the earphone positioning guidance comprising an elastic hinge disposed between the main body (2) and the earphone (6).

20. A wireless headset according to claim 18, further comprising:
the earphone having a shape protruding from the main body, and rotatably attached to the main body,
the extender for enabling the earphone to stay apart from the main body at an extracted position;
a stopper (82) formed in the extender, and enabling the earphone in at least one of the extracted position and a retracted position to remain stationary,
a supporter (83) for interacting with the stopper (82) to support the stopper in order to keep the earphone stationary either one of the extracted position or the retracted position,
an extraction/retraction actuator (86) for actuating the earphone from the extracting position to the retracting position, vise versa by engaging or disengaging the stopper from the supporter, and
an elastic member (85) disposed between the earphone and the main body to exert an elastic force for resuming the earphone from the extracting position to the retracting position, vise versa.

21. A wireless headset according to claim 20, further comprising a rotation controller for detecting an operation of the earphone to control power supplied to the wireless headset.

22. A wireless headset according to claim 1, further comprising:
the earphone perpendicularly rotatable with respect to a longitudinal direction of the main body,
the extender for enabling the earphone in a retracted position to remain separated from the body,
a rotating shaft arranged at an end of the extender,
a rotating guidance rotatable together with the rotating shaft, and having a polyhedral shape to contact with a plan surface, and
an elastic member for exerting elastic force to rotate the rotating guidance in a direction to be in surface contact with the planar portion of the rotating guidance.

23. The wireless headset according to claim 22, further comprising a rotation controller for detecting an operation of the earphone and an earphone positing guidance to control for supplying power to the wireless headset.

24. A wireless headset according to claim 1, further comprising:
the earphone rotatable with respect to the main body;
the extender arranged between the earphone and the main body, the extender enabling the earphone in the extracted position to have proper distance from the main body than in the retracted position;
a rotator connected to the earphone to rotate together with the earphone;
a flexible portion connected to the rotator, and having at least two indentations; and
a rotation stopper for interacting with the flexible portion to keep the earphone stationary while the earphone is being used in order to prevent rotation of the rotator.

25. The wireless headset according to claim 24, wherein the earphone is partially inserted into an earphone guide recess formed in an exterior of the body, and said earphone is retracted vertically or horizontally with respect to a longitudinal direction of the body.

26. The wireless headset according to claim 25, further comprising a rotation detector for detecting an operation of the earphone and the rotator to control power supplied to the wireless headset.

27. A wireless headset according to claim 1, further comprising:
the earphone movable with respect to the body;
the extender for enabling the earphone to remain separated from the main body in an extracted position;
a rotating shaft connected to the earphone to move together with the earphone;
a flexible portion having a protrusion-indentation structure, and formed on one side of the rotating shaft,
a protruding rotation stopper for meshing with the protrusion-indentation structure of the flexible portion to prevent rotation of the rotating shaft; and
an elastic member for providing the rotation stopper with an elastic force toward the flexible portion.

28. The wireless headset according to claim 27, further comprising a rotation detector for detecting an operation of at least one of the earphone and the rotating shaft to control power supplied to the wireless headset.

29. A wireless headset according to claim 1, further comprising:
the earphone movable with respect to the main body;
the extender for enabling the earphone to remain separated from the body in an extracted position;
a rotating shaft connected to the earphone to rotate together with the earphone;
a flexible portion shaped into a gear, and arranged at a portion of the rotating shaft;
a ratchet for meshing with the gear of the flexible portion to prevent rotation of the rotating shaft;
a ratchet shaft for supporting the ratchet; and
an elastic member for providing an elastic force to a rotating position of the ratchet.

30. The wireless headset according to claim 29, further comprising a rotation detector for detecting an operation of at least one of the earphone and the rotating shaft to control power supplied to the wireless headset.

31. A wireless headset according to claim 1, further comprising:
the earphone movable with respect to the main body;
the extender for enabling the earphone to remain separated from the main body in an extracted position;
a rotating shaft connected to the earphone to move together with the earphone;
a non-circular flexible portion arranged at a portion of the rotating shaft, and having at least two indentations;
a rotation stopper meshed with at least one of the indentations to prevent rotation of the rotating shaft; and
an elastic member for providing an elastic force so that the rotation stopper maintains an initial position.

32. The wireless headset according to claim 31, wherein the indentations of the flexible portion are formed in positions corresponding to the extracted position and a retracted position, respectively, or in at least three positions corresponding to a rotation range of the earphone.

33. The wireless headset according to claim 31, further comprising a rotation detector for detecting an operation of at least one of the earphone and the rotating shaft to control power supplied to the wireless headset.

34. A method of controlling a wireless headset, the method comprising steps of:
extracting an earphone,
detecting the extraction of the earphone to activate a rotation detector, and
switching the wireless headset to a connection mode by the rotation detector.

35. A method of controlling according to claim 34, the method further comprising the steps of:
retracting the earphone,
detecting the retraction of the earphone to activate a rotation detector, and
switching the wireless headset to a standby mode by the rotation detector.
